(19) United States
(12) Patent Application Publication
(10) Pub. No.: US 2005/0053180 A1
(43) Pub. Date: Mar. 10, 2005

(54) Integrated circuit capable of high speed operations

(75) Inventors: Koichi Nose, Tokyo (JP); Masayuki Mizuno, Tokyo (JP)

Correspondence Address: FOLEY AND LARDNER;SUITE 500, 3000 K STREET NW, WASHINGTON, DC, 20007, US

(73) Assignee: NEC CORPORATION

(21) Appl. No.: 10/933,406

(22) Filed: Sep. 3, 2004

(30) Foreign Application Priority Data
Sep. 4, 2003 (JP) 2003-312690

(51) Int. Cl. H04L 7/00

(52) U.S. Cl. 375/354

(57) ABSTRACT

A semiconductor integrated circuit is disclosed for enabling faster operations than a clock frequency using multi-phase clocks, A clock generator circuit generates multi-phase clocks comprised of a plural-phase clocks which are the same in clock frequency but different in phase from one another. A clock distributor distributes the multi-phase clocks generated by the clock generator circuit within the integrated circuit. A logic circuit operates at an operating frequency higher than the clock frequency in synchronization with the multi-phase clocks generated by the clock generator circuit and distributed by the clock distributor.

### BACKGROUND OF THE INVENTION

1. Field of the Invention

The present invention relates to a distribution of clocks in an integrated circuit, and more particularly, to a distribution of clocks in an integrated circuit which is required to operate at high speeds.

2. Description of the Related Art

In the field of the semiconductor integrated circuits, higher speeds are strongly required for operations, and faster operations have been achieved by a variety of approaches.

In a semiconductor integrated circuit, it is a clock that determines operation timings of logic circuits, so that the operating speed of the integrated circuit is determined by the frequency of the clock. For increasing the speed of operations performed in a semiconductor integrated circuit, the most simple approach may involve increasing the frequency of a clock distributed to logic circuits.

However, a clock frequency exceeding 10 GHz would cause an increase in the resistance of clock distribution wires due to parasitic inductance and conductor skin effect. Disadvantageously, the increased resistance of the clock distribution wires results in a notable deterioration of the clock waveform and a prominent increase in delays of distributed clocks, leading to an increased clock skew (variations in clock arrival time).

Further, with the addition of an increase in delay of rising and falling edges of clocks, a collapsed duty ratio (the ratio of a high-level duration to a low-level duration of a clock waveform), and so on, the clock waveform could be deteriorated to lose the dock. For the reasons set forth above, attempts for achieving higher operating frequencies have been limited from the need for ensuring an operation margin of logic circuits.

Referring to FIG. 1, integrated circuit 3301 comprises single-phase clock generator circuit 3302, clock distribution circuit 3303, and logic circuit 3304.

Single-phase clock generator circuit 3302 generates single-phase clock CK1. Clock distribution circuit 3303 distributes clock CK1 generated by single-phase clock generator circuit 3302 into logic circuit 3304. Logic circuit 3304 comprises a plurality of flip-flops 3305 and combination circuit 106. Each flip-flop 3305 in logic circuit 3304 fetches data at a rising or a falling timing of clock CK1. Thus, the operating frequency of integrated circuit 101 is the same as the frequency of the clock.

For increasing the speed of a conventional semiconductor integrated circuit which distributes a clock as described above, it is necessary to increase the frequency of the clock to a similar level to the operating frequency of the integrated circuit. This requirement makes the aforementioned problems such as clock skew inevitable.

Currently, an H-tree scheme has been widely used for distributing high-speed clocks. FIG. 2 is a schematic diagram illustrating a clock distribution configuration based on the H-tree scheme. A semiconductor integrated circuit in FIG. 2 comprises single-phase clock generator circuit 3402, buffers 3403, 3405, 3407, 3409, and clock wires 3404, 3406, 3408.

Single-phase clock generator circuit 3402 generates a single-phase clock. First-stage buffer 4303 branches the clock generated by single-phase clock generator circuit 3402 into two from the center of clock wire 3404 toward both ends of the same. Second-stage buffers 3405 are connected to both ends of clock wire 3404, each for again dividing the clock into two toward both ends of associated clock wire 3406. Similarly, each of buffers 3407 branches the clock into two toward buffers 3409 at both ends of clock wire 3408.

The H-tree scheme provides a clock distribution configuration which branches a clock into an H-shaped tree using buffers, and employs all clock wires having the same length and same load to suppress the clock skew. However, the H-tree scheme experiences difficulties in distributing a high-speed clock due to long clock wire 3404 driven by first-stage buffer 3403.

A SPINE scheme has also been employed as another conventional approach for distributing a high-speed clock. A semiconductor integrated circuit illustrated in FIG. 3 comprises single-phase clock generator circuit 3502, clock distribution circuit 3503, SPINEs 3504, buffers 3505, and clock wires 3506.

Single-phase clock generator circuit 3502 generates a single-phase clock. Clock distribution circuit 3503 has a plurality of buffers for branching the clock generated by single-phase clock generator circuit 3502 into a plurality of basic SPINEs 3504. A plurality of buffers 3505 are connected to each SPINE 3504. Buffers 3505 distribute the clock of SPINEs 3504 into clock wires 3506 which is laid out, for example, in a grid shape. The clock is distributed to the entire semiconductor integrated circuit through clock wires 3506. This SPINE scheme has the advantage of facilitating the designing because the buffers are disposed in a linear fashion at regular intervals, as illustrated In FIG. 3.

However, in the SPINE scheme, the length of wires associated with basic SPINEs 3504 also constitutes a factor of limiting the distribution of a high-speed clock in addition to the problem of the operating frequency, as described above, which develops in clock distribution circuit 3503. While the conventional distribution of high-speed clock implies a variety of problems as described above, similar problems are encountered in the transmission of high-speed signals other than the clock.

An approach using an n-phase clock (n is a natural number equal to or larger than two) has been conventionally used for alleviating the problem of clock skew.

Referring to FIG. 4, a conventional semiconductor integrated circuit comprises multi-phase clock generator circuit 3601, flip-flops 3602, 3603, 3604, and combination circuits 3605, 3606. As illustrated in FIG. 5, multi-phase clock generator circuit 3601 generates a plurality of clocks CK1, CK2, CK3 which are the same in frequency but different in phase. Flip-flops 3603, 3603, 3604 fetch data at different timings from one another. Flip-flop 3602 fetches data with clock CK1; flip-flop 3603 fetches data with clock CK2; and flip-flop 3604 fetches data with clock CK3. In this way, flip-flops 3602, 3603, 3604, sandwiching respective combination circuits 3605, 3606, operate in order. In this way, data of the semiconductor integrated circuit (data 1, 2 in FIGS. 4 and 5) is transmitted faster than the frequency of the clocks, as illustrated in FIG. 5.

Another conventional approach applies multi-phase clocks to a dynamic circuit (see, for example, JP-11-212664-A).

Referring to FIG. 6, a semiconductor integrated circuit comprises multi-phase clock generator circuit 3601, flip-flop 5001, and dynamic logic circuit 5002. Multi-phase clock generator circuit 3601, which is the same as that shown in FIG. 4, generates a plurality of clocks CK1, CK2, CK3 which are the same in frequency but different in phase, as illustrated in FIG. 5, and distributes clocks CK1, CK2, CK3 to flip-flop 5001 and dynamic logic circuit 5002.

Flip-flop 5001 fetches and delivers data in synchronization with clock CK1.

Dynamic logic circuit 5002 receives some of distributed multi-phase clocks (clocks CK2, CK3 in FIG. 6), and operates in synchronization with the clocks distributed thereto.

With the foregoing configuration, this approach eliminates blocked signals due to a preparatory charging time, and permits data to be transmitted faster than the clock frequency, as is the case with the approach illustrated in FIG. 4.

By thus shifting the timings of respective data using the n-phase clocks, it is possible to prevent data passage and to transmit data at high speeds. According to this configuration, an input signal is reflected to the output in a shorter time because data is transmitted at high speeds, whereas the operating frequency is not increased in view of throughput because the operating frequency of the flip-flop is the same as the clock frequency and therefore, the interval between data is the same as the clock frequency. In addition, the conventional approach using n-phase clocks can experience a problem of a deteriorated waveform and a resulting loss of signals if there is a long wire through which the signals are transmitted, due to increased operating frequencies of combination circuits 3605, 3606.

On the other hand, semiconductor integrated circuit capable of switching the frequency of a clock have been conventionally used for reducing power consumption (see, for example, JP-5-94227-A).

Referring to FIG. 7, a conventional semiconductor integrated circuit comprises operating frequency control circuit 3801, clock generator circuit 3802, and logic circuit 3803. Under the control of operating frequency control circuit 3801, clock generator circuit 3802 switches the frequency of a clock supplied to logic circuit 3803. The switching of the clock frequency takes predetermined time 3901, as shown in FIG. 8. Due to the time required for the switching, the conventional semiconductor integrated circuit must stop the operation of logic circuit 3803 until clock generator circuit 3802 has switched the clock frequency. This is a wasteful time for a semiconductor integrated circuit which is required to perform high-speed operations.

As appreciated from the foregoing, there are a variety of problems in speeding the operation of semiconductor integrated circuits. Particularly prominent among such problems are a problem caused by clock skew in the distribution of clocks exceeding 10 GHz, a loss of a clock due to a deteriorated waveform, and the like, so that the request for higher speeds is left unsatisfied.

### SUMMARY OF THE INVENTION

It is an object of the present invention to provide a semiconductor integrated circuit which is capable of performing high-speed operations.

To achieve the above object, an integrated circuit according to the present invention, which operates using multi-phase clocks, includes a clock supply unit and at least one logic circuit.

The clock supply unit generates multi-phase clocks comprised of plural-phase clocks which are the same in clock frequency but different in phase from one another for distribution within the integrated circuit.

The logic circuit operates at an operating frequency higher than the clock frequency in synchronization with the multi-phase clocks supplied thereto by the clock supply unit.

According to one aspect of the present invention, the clock supply unit has a clock generator circuit and a clock distributor. The clock generator circuit generates the multi-phase clocks. The clock distributor distributes the multi-phase clocks generated by the clock generator circuit within the integrated circuit.

According to another aspect of the present invention, the clock generator circuit generates a single-phase or two-phase clocks at the clock frequency for use as a reference signal. The clock distributor distributes the reference signal generated by the clock generator circuit within the integrated circuit, and transforms the reference signal distributed thereto into a multi-phase clocks which are applied to the logic circuit.

According to one aspect of the present invention, the logic circuit has a data holder circuit. The data holder circuit is synchronized to two or more clocks included in the multi-phase clocks to operate at an operating frequency twice or more as high as the clock frequency. In this event, the data holder circuit may include a plurality of data holding elements arranged in parallel for holding data in synchronization with each of the two or more clocks.

The above and other objects, features, and advantages of the present invention will become apparent from the following description with reference to the accompanying drawings which illustrate examples of the present invention.

### BRIEF DESCRIPTION OF THE DRAWINGS

FIG. 1 is a block diagram illustrating the circuit components involved in a clock distribution in a conventional semiconductor integrated circuit;

FIG. 2 is a schematic diagram illustrating the circuit components involved in a clock distribution based on a H-tree scheme;

FIG. 3 is a block diagram illustrating the circuit components involved in a clock distribution based on a SPINE scheme;

FIG. 4 is a block diagram illustrating the conventional semiconductor integrated circuit using n-phase clocks;

FIG. 5 is a timing diagram representing the operation of the semiconductor integrated circuit in FIG. 4;

FIG. 6 is a block diagram Illustrating a conventional semiconductor integrated circuit in which multi-phase clocks are applied to a dynamic circuit;

FIG. 7 is a block diagram illustrating a conventional semiconductor integrated circuit which is capable of switching the frequency of a clock;

FIG. 8 is a timing diagram representing the operation of the semiconductor integrated circuit illustrated in FIG. 7 when it switches the clock frequency;

FIG. 9 is a block diagram illustrating a semiconductor integrated circuit according to a first embodiment of the present invention;

FIG. 10 is a schematic diagram illustrating a flip-flop shown in FIG. 9;

FIG. 11 is a timing diagram representing the operation of the flip-flop Illustrated in FIG. 10;

FIG. 12 is a block diagram illustrating another exemplary configuration of the flip-flop shown In FIG. 9;

FIG. 13 is a schematic circuit diagram illustrating a pulse latch circuit shown in FIG. 12;

FIG. 14 is a timing diagram representing the operation of the pulse latch circuit shown in FIG. 12;

FIG. 15 is a schematic circuit diagram illustrating an exemplary configuration of a clock distribution circuit shown in FIG. 9;

FIG. 16 is a schematic diagram illustrating a clock distributor to which the H-tree scheme is applied;

FIG. 17 is a block diagram illustrating a semiconductor integrated circuit including a skew correction circuit in a clock distributor;

FIG. 18 is a block diagram illustrating an exemplary configuration of the skew correction circuit shown in FIG. 17;

FIG. 19 is a timing diagram representing the operation of phase interpolation circuits;

FIG. 20 is a timing diagram representing a clock skew correcting operation performed by the skew correction circuit in FIG. 18;

FIG. 21 is a block diagram illustrating another exemplary configuration of the skew correction circuit shown in FIG. 17;

FIG. 22 is a graph showing the phase interpolation characteristics of the phase interpolation circuits shown in FIGS. 18 and 21;

FIG. 23 is a timing diagram representing the clock skew correcting operation performed by the skew correction circuit illustrated in FIG. 21;

FIG. 24 is a block diagram illustrating a semiconductor integrated circuit which includes a waveform converter circuit in a clock distributor;

FIG. 25 is a schematic circuit diagram illustrating an exemplary configuration of the waveform converter circuit shown in FIG. 24;

FIG. 26 is a timing diagram representing the operation of the waveform transform circuit illustrated in FIG. 25;

FIG. 27 is a schematic circuit diagram illustrating another exemplary configuration of the waveform transform circuit illustrated in FIG. 26;

FIG. 28 is a timing diagram representing the operation of the waveform transform circuit illustrated in FIG. 27;

FIG. 29 is a schematic circuit diagram illustrating a flip-flop which is substituted for that Illustrated in FIG. 27;

FIG. 30 is a block diagram illustrating a semiconductor integrated circuit which transforms a single-phase clock to n-phase clocks and supplies the n-phase clocks to a logic circuit;

FIG. 31 is a block diagram illustrating a semiconductor integrated circuit which transforms n-phase clocks to a single-phase clock for supplying to a logic circuit;

FIG. 32 is a block diagram illustrating an example of the clock distributor shown in FIG. 31 to which the SPINE scheme is applied;

FIG. 33 is a schematic circuit diagram illustrating an example of the clock distributor shown in FIG. 31 to which the H-tree scheme is applied;

FIG. 34 is a block diagram illustrating a semiconductor integrated circuit according to a second embodiment around a dynamic logic circuit;

FIG. 35 is a block diagram illustrating the dynamic circuit shown in FIG. 34;

FIG. 36 is a timing diagram representing the dynamic circuit;

FIG. 37 is a block diagram illustrating a semiconductor integrated circuit according to a third embodiment around a dynamic logic circuit;

FIG. 38 is a block diagram illustrating a semiconductor integrated circuit according to a fourth embodiment around a dynamic logic circuit;

FIG. 39 is a block diagram illustrating a semiconductor integrated circuit according to a fifth embodiment around a dynamic logic circuit;

FIG. 40 is a block diagram illustrating a signal divider circuit shown in FIG. 39;

FIG. 41 is a timing diagram representing the operation of the signal divider circuit;

FIG. 42 is a schematic circuit diagram illustrating a signal combiner circuit shown in FIG. 39; and

FIG. 43 is a timing diagram representing the operation of the signal combiner circuit.

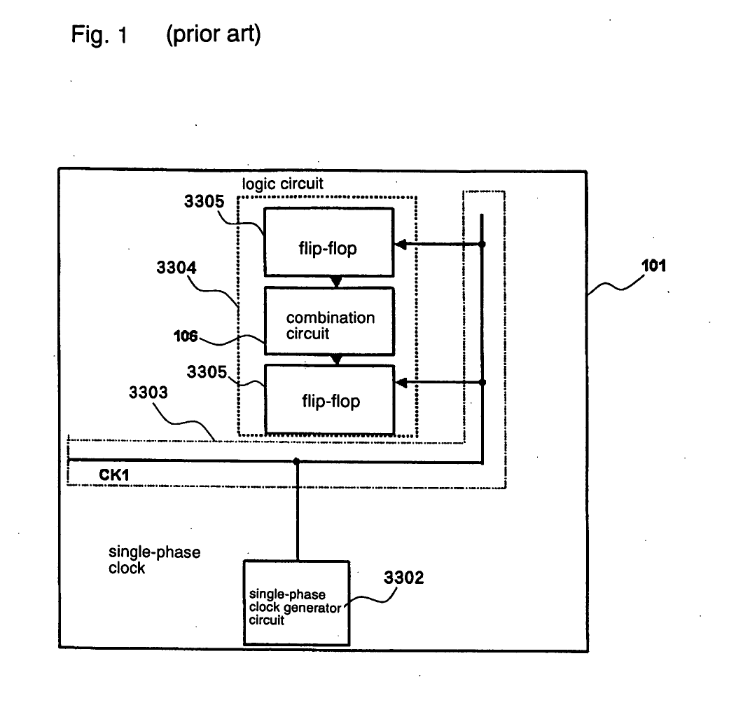

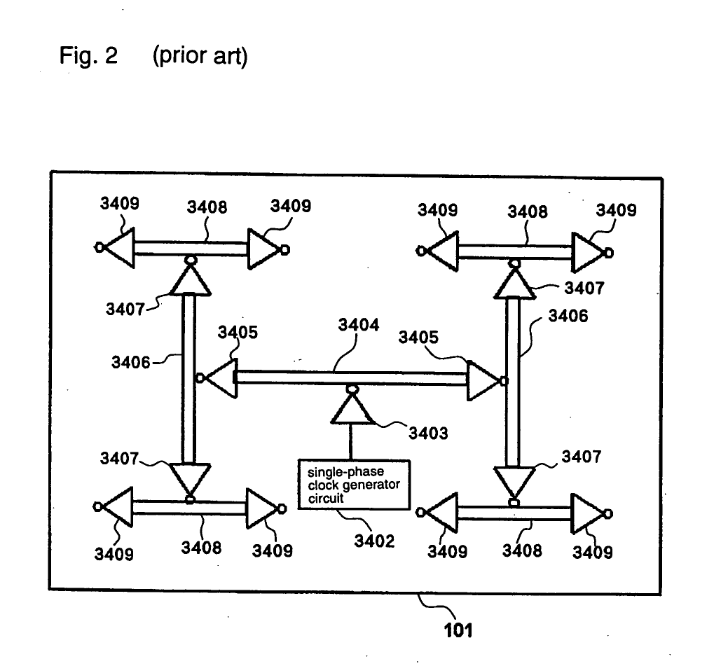

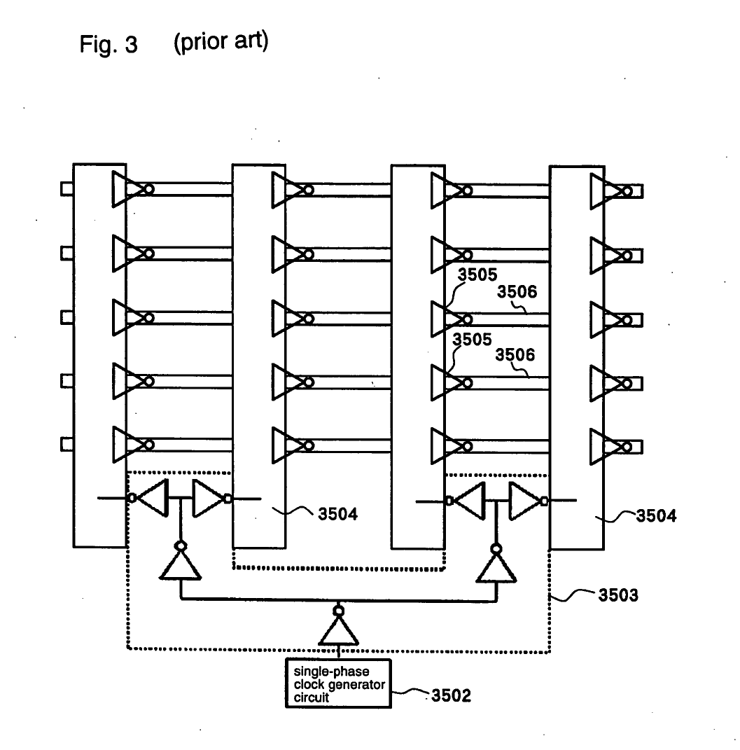

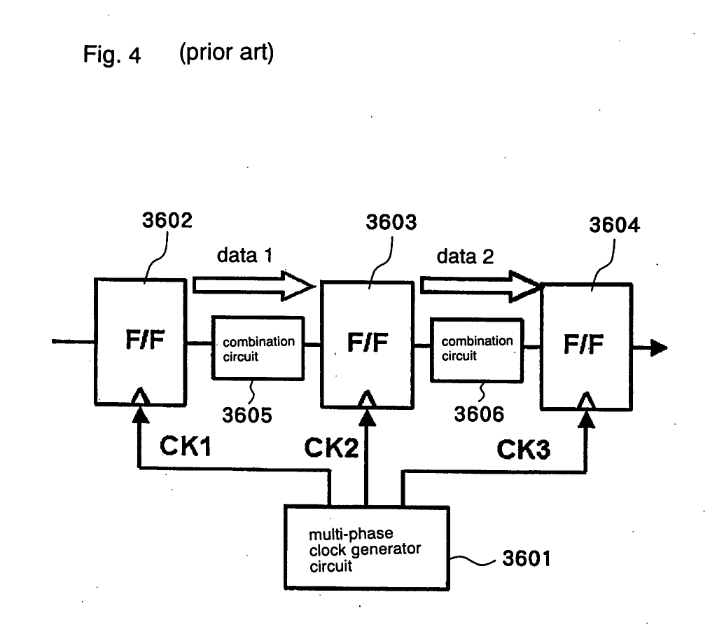

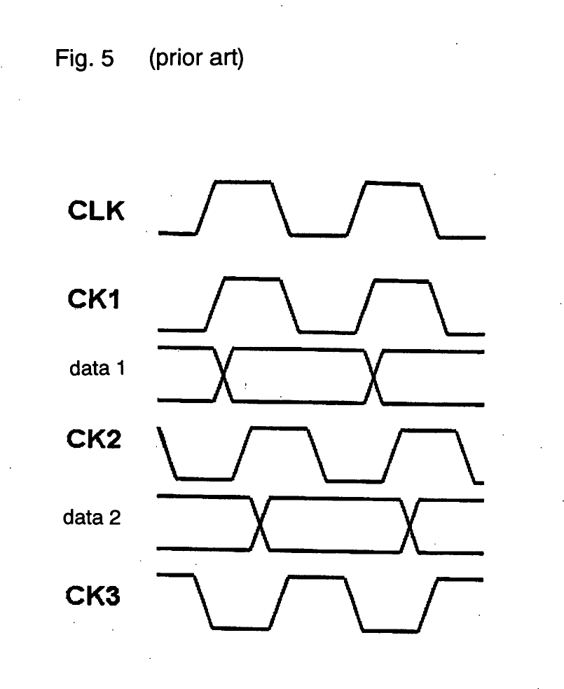

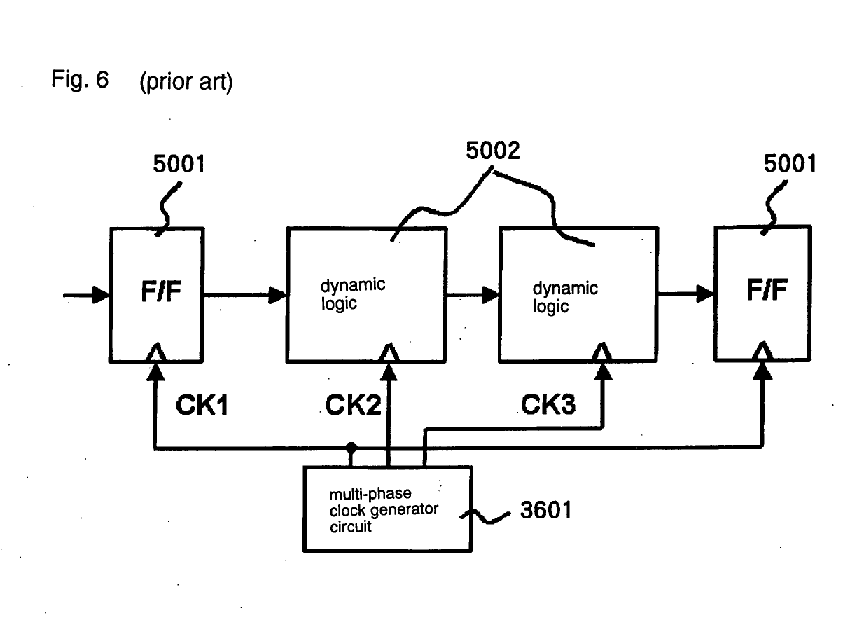

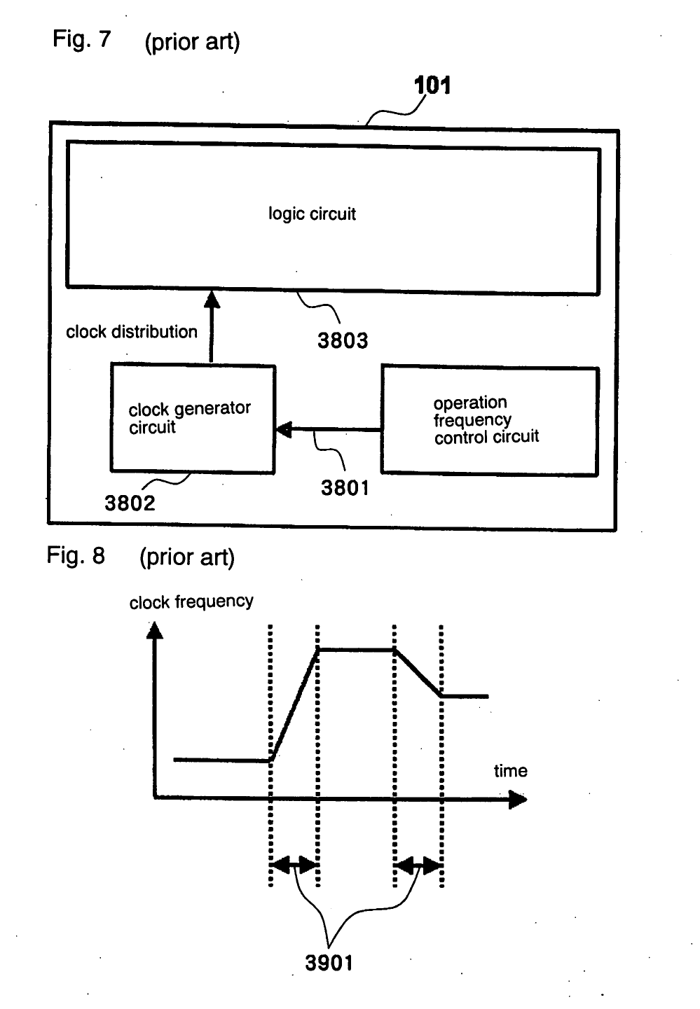

### EMBODIMENTS

Embodiments of the present invention will be described In detail with reference to the accompanying drawings.

(First Embodiment)

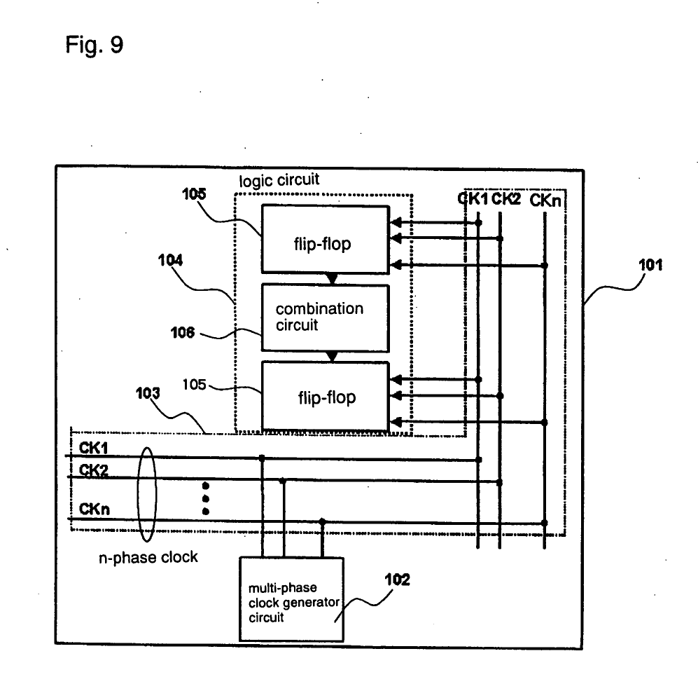

A first embodiment of the present invention features a semiconductor integrated circuit which employs multi-phase clocks to increase the operating frequency of a logic circuit n times as high as the frequency of the clocks. Referring to FIG. 9, semiconductor integrated circuit 101 comprises multi-phase clock generator circuit 102, clock distributor 103, and logic circuit 104. Generally, in a semiconductor integrated circuit, a clock is supplied from a clock supply unit to a logic circuit, such that the logic circuit operates in synchronization with the clock. Here, multi-phase clock generator circuit 102 and clock distributor 103 make up a clock supply unit.

Multi-phase clock generator circuit 102 generates n-phase (n is a natural number equal to or larger than two) clocks CK1-CKn which are the same in frequency but different in phase from one another. Assume that clocks CK1-CKn are at frequency f. Clock distributor 103 comprises a circuit for distributing each of a plurality of clocks CK1-CKn, and distributes n-phase clocks CK1-CKn to the entire semiconductor integrated circuit. Clock distributor 103 has clock wires equal in length and equal in load to one another to reduce clock skew produced in clock distributor 103.

Logic circuit 104 comprises flip-flop 105 and combination circuit 106. Flip-flop 105 fetches data using n-phase clocks CK1-CKn distributed by clock distributor 103. Flip-flop 105 may use all or some of n-phase clocks CK1-CKn. In this way, the semiconductor integrated circuit operates in synchronization with n-phase clocks CK1-CKn.

N-phase clocks at frequency f generated by multi-phase clock generator circuit 102 are supplied to flip-flop 105 of logic circuit 104 by clock distributor 103, and flip-flop 105 operates at a frequency higher than frequency f in synchronization with a plurality of n-phase clocks CK1-CKn, thus permitting the semiconductor integrated circuit to alleviate the problem related to the clock and operate the logic circuit included therein at high speeds.

Logic circuit 104 need not operate at all times in synchronization with all of the n-phase clocks. Provided that logic circuit 104 operates In synchronization with two or more clocks, logic circuit 104 can operate at an operating frequency higher than the clock frequency. For example, when logic circuit 104 operates in synchronization with i (i is an natural number equal to or larger than two and equal to or smaller than n) of the n-phase clocks, the operating frequency of logic circuit 104 is increased i times as high as the clock frequency f. When a desired operating frequency of logic circuit 104 is fchip, each clock frequency generated by multi-phase clock generator circuit 12 can be limited to fchip/j.

(First Exemplary Implementation)

Now, description will be made on a first exemplary implementation in the first embodiment.

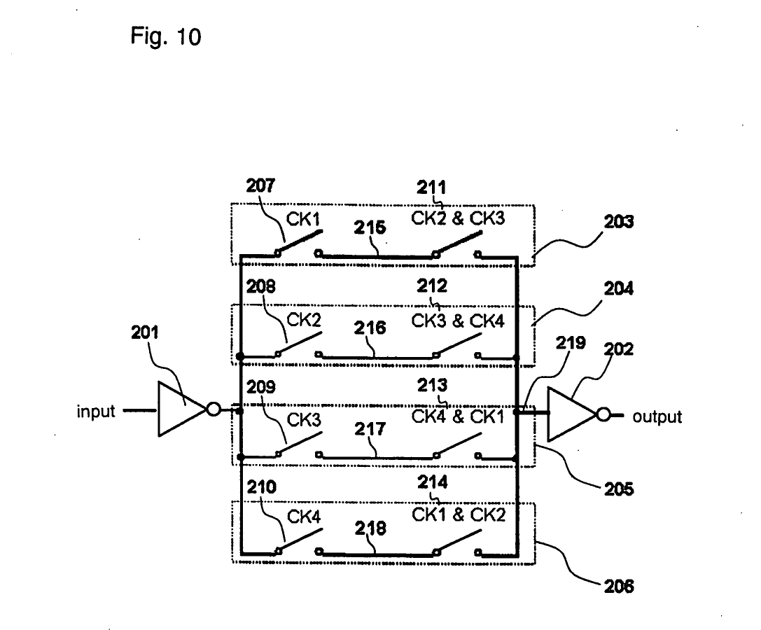

In the first exemplary implementation, flip-flop 105 shown in FIG. 9 has a plurality of data holder elements 203-206 arranged in parallel for holding data In synchronization with different clocks, as illustrated in FIG. 10. Flip-flop 105 functions as a data holder circuit which operates in synchronization with n-phase (four-phase in the example of FIG. 10) clocks.

Referring to FIG. 10, flip-flop 105 comprises input inverter 201, output inverter 202, and switch circuits 207-214. Switch circuit 207 on a master side is connected in series with switch circuit 211 on a slave side. Similarly, switch circuit 208 on the master side is connected in series with switch circuit 212 on the slave side; switch circuit 209 on the master side with switch circuit 213 on the slave side; and switch circuit 210 on the master side with switch circuit 214 on the slave side. Then, these circuits, each having two switches connected in series, are connected between input inverter 201 and output inverter 202 in parallel with one another.

Switch circuit 207 on the master side is conductive when clock CK1 is at high level. Switch circuit 208 is conductive when clock CK2 is at high level. Switch circuit 209 is conductive when clock CK3 is at high level. Switch circuit 210 is conductive when clock CK4 is at high level.

Also, switch circuit 211 on the slave side is conductive when clock CK2 and clock CK3 are both at high level. Switch circuit 212 is conductive when clock CK3 and clock CK4 are both at high level. Switch circuit 213 is conductive when clock CK4 and clock CK1 are both at high level. Switch circuit 214 is conductive when clock CK1 and clock CK2 are both at high level.

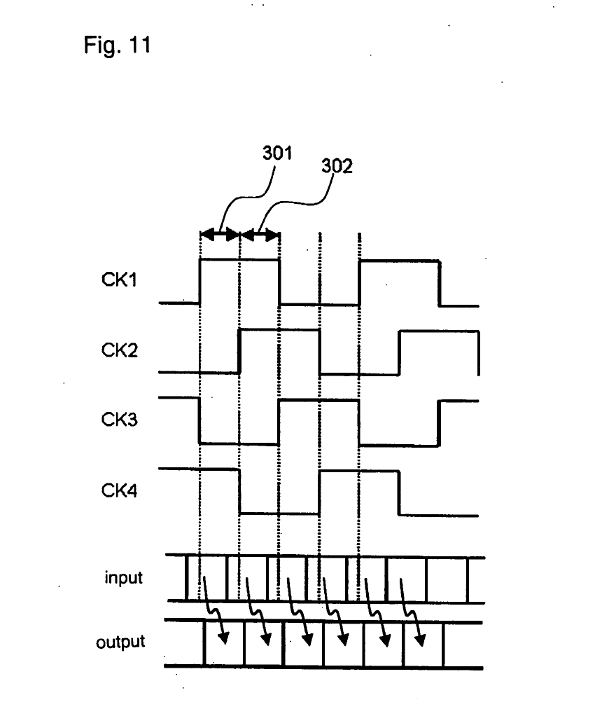

FIG. 11 is a timing diagram representing the operation of flip-flop 105 illustrated in FIG. 10. Referring to FIG. 11, in section 301, clocks CK1 and CK4 are at high level, while the remaining clocks are at low level.

Therefore, on the master side, switch circuits 207, 210 are conductive. This causes an input signal to propagate to intermediate node 215 which is a connection between switch circuit 207 and switch circuit 211, and to intermediate node 218 which is a connection between switch circuit 210 and switch circuit 214, and the values of the input signal are stored at these nodes.

On the slave side, in turn, switch circuit 213 is conductive. In this event, since no switch circuit is conductive except for switch circuit 213 on the slave side, a value stored at intermediate node 217, which is a connection between switch circuit 209 and switch circuit 213, is delivered from output inverter 202. Also, since switch circuit 209 is not conductive on the master side, no signal will introduce into intermediate node 217, which is a connection between switch circuit 209 and switch circuit 213, and collide with a signal stored at this node.

In section 302 in FIG. 11, clocks CK1 and CK2 are at high level, while the remaining clocks are at low level.

Therefore, on the master side, switch circuits 207, 208 are conductive. This causes a signal to propagate to intermediate nodes 215, 216, respectively, and the values of the input signal are stored at these nodes.

On the slave side, in turn, switch circuit 214 is conductive. In this event, since no switch circuit is conductive except for switch circuit 214 on the slave side, a value stored at intermediate node 218 is delivered from output inverter 202. Also, since switch circuit 210 is not conductive on the master side, no signal will introduce into intermediate node 218 and collide with a signal stored at this node.

In this way, each time one of clocks CK1-CK4 rises, flip-flop 105 of FIG. 9 fetches data and delivers the same.

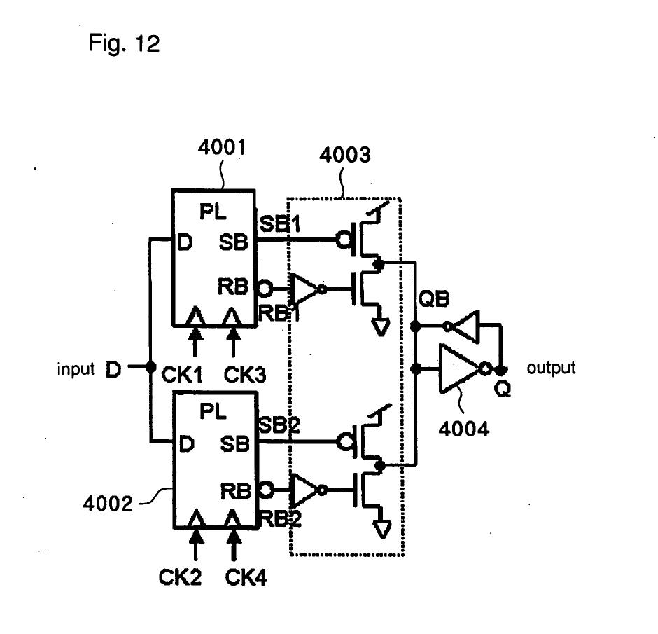

FIG. 12 is a block diagram illustrating another exemplary configuration of the flip-flop shown in FIG. 9. In this exemplary configuration, flip-flop 105 comprises a plurality of pulse latch circuits 4001, 4002 for holding data in synchronization with different clocks, and push-pull circuit 4003 for determining the value of output Q of flip-flop 105 in accordance with the outputs of pulse latch circuits 4001, 4002.

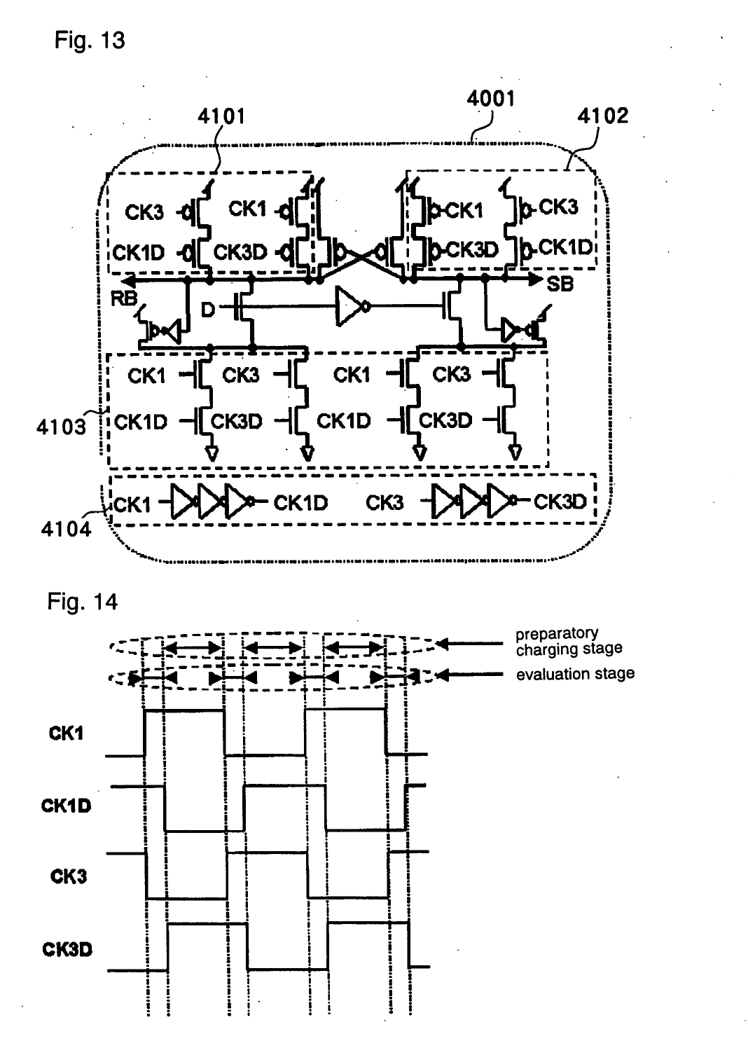

FIG. 13 is a schematic circuit diagram illustrating the configuration of the pulse latch circuit shown in FIG. 12, and FIG. 14 is a timing diagram representing the operation of the pulse latch circuit. Pulse latch circuits 4001, 4002 are identical in configuration, and pulse latch circuit 4001 is illustrated in FIG. 13. Referring to FIG. 13, pulse latch circuit 4001 comprises preparatory charging circuits 4101, 4102, determination circuit 4103, and delayed clock generator circuit 4104.

As illustrated in FIG. 14, delayed clock generator circuit 4104 inverts and delays clock CK1 to generate clock CK1D, inverts and delays clock CK3 to generate clock CK3D, and applies clocks CK1D, CK3D to preparatory charging circuits 4104, 4102 and determination circuit 4103.

In FIG. 14, for a period from the time clock CK1 rises to the time clock CK1D falls, determination circuit 4103 is conductive, while preparatory charging circuits 4101, 4102 are nonconductive. Therefore, the values of outputs RB, SB of pulse latch circuit 4001 are determined by the value of input signal D. This period is labeled an evaluation period.

On the other hand, for a period from the time clock CK1D falls to the time clock CK3 rises, preparatory charging circuit 4101 is conductive, while determination circuit 4103 is nonconductive. Therefore, the values of outputs RB, SB of pulse latch circuit 4001 are at high level irrespective of the value of input signal D. This period is labeled a preparatory charging period.

Subsequently, with similar operations to the above, one of pulse latch circuits 4001, 4002 enters the evaluation period for a fixed time period each time one of clocks CK1-CK4 rises.

Push-pull circuit 4003 is a combiner circuit which operates while pulse latch circuits 4001, 4002 are in the evaluation period to change the value of signal OB, and sequentially delivers values acquired during the evaluation period of each pulse latch circuit 4001, 4002. An inverted version of signal QB is delivered to output Q of flip-flop 105. On the other hand, when pulse latch circuits 4001, 4002 are in the preparatory charging period, push pull circuit 4003 is not conductive, so that the values of signal QB and output signal 0 are maintained. From the foregoing, each time one of clocks CK1 CK4 rises, flip-flop 105 in this exemplary configuration fetches data and delivers the same.

In this embodiment, the SPINE scheme is employed, as an example, for the wiring layout in clock distributor 103 for distributing clocks therethrough.

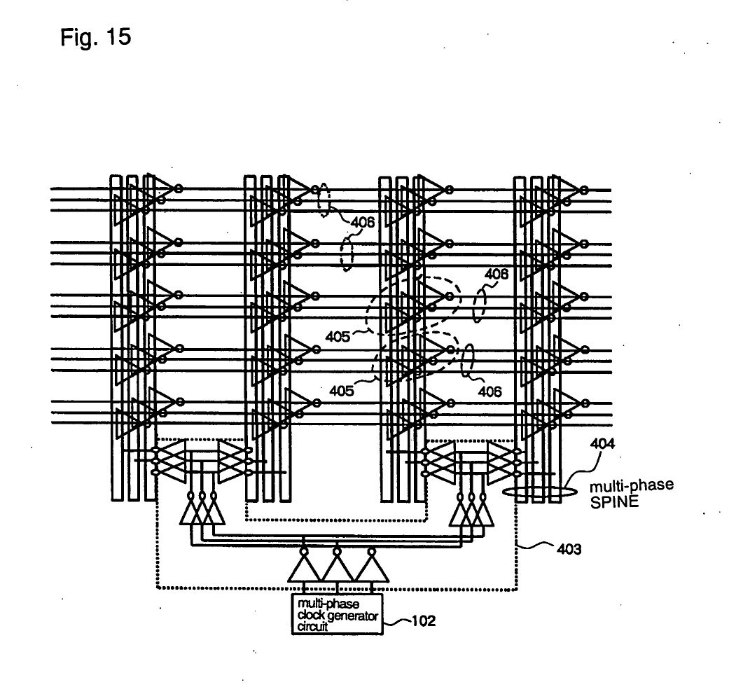

Referring to FIG. 15, clock distributor 103 comprises clock branch circuit 403, multi-phase SPINE 404, buffers 405, and clock wires 406.

In order to allow for distribution of n-phase clocks generated by multi-phase clock generator circuit 102, n SPINEs are provided to implement multi-phase SPINE 404.

It is thought that the provision of n wires would cause an increase in the area occupied by SPINE wires and an increase in the number of buffers. However, since multi-phase clocks can contribute to a reduction in the frequency of each clock, the width of wires, and the size of buffers, it is possible to limit an increase in the area and power consumption due to Fe provision of multi-phase clocks. For example, the frequency of four-phase clocks may be set at 2.5 GHz in order to operate a semiconductor integrated circuit at 10 GHz.

Clock branch circuit 403, which comprises a plurality of buffers, branches each of n-phase clocks CK1-CKn generated by multi-phase clock generator circuit 102 to each SPINE of basic multi-phase SPINE 404. A plurality of buffer groups 405 are connected to each SPINE of multi-phase SPINE 404. Buffer groups 405, each of which comprises n buffers, distribute clocks on respective SPINEs to clock wires 406 which comprise n clock wires. Clock wires 406 distribute n-phase clocks CK1-CKn over the entire semiconductor integrated circuit.

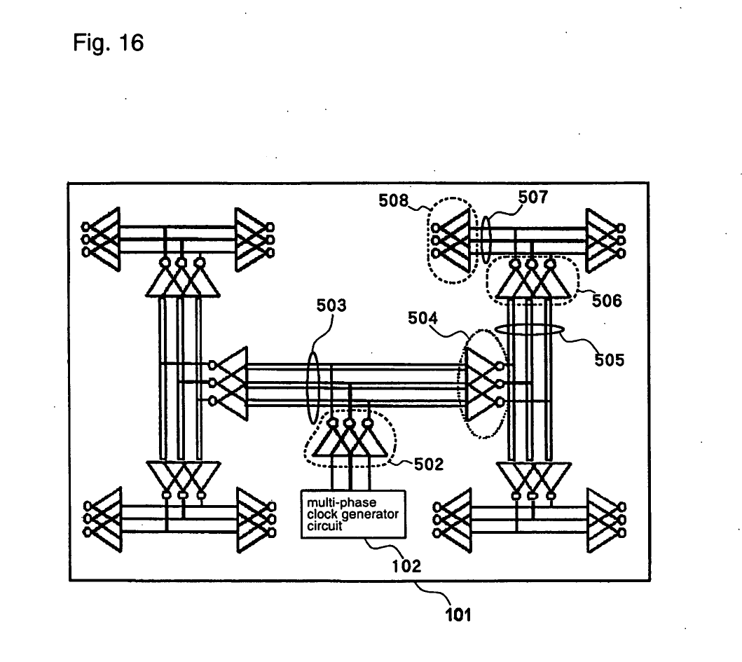

Instead of the SPINE scheme, the H-tree scheme may be applied to clock distributor 103 in this embodiment. Referring to FIG. 16, clock distributor 103 in another configuration comprises buffer groups 502, 504, 506, 508, and lock wire groups 503, 505, 507.

First buffer group 502 branches each of n-phase clocks CK1-CKn generated by multi-phase clock generator circuit 102 into two from the center of each of clock wires belonging to clock wire group 503 toward both ends of the clock wire. Respective buffers belonging to second buffer groups 504 are connected to both ends of respective clock wires belonging to clock wire group 503, to further branch the clocks toward both ends of respective clock wires belonging to clock wire group 505. Similarly, each of buffers belonging to buffer groups 506 branch a clock into two toward buffers belonging to buffer group 508 at both ends of associated one of clock wires belonging to clock wire group 505.

(Second Exemplary Implementation)

In this embodiment, clock distributor 103 can take a variety of configurations. Clock distributor 103 may not only simply distribute clocks but include an adjuster circuit for adjusting the phase and waveform. For example, clock distributor 103 in a second exemplary implementation includes a skew correction circuit for correcting clock skew.

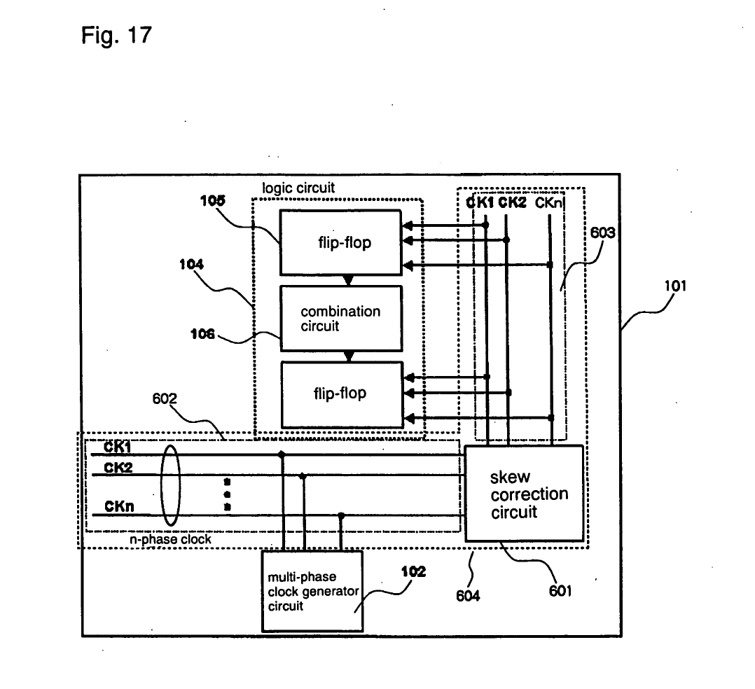

FIG. 17 is a block diagram illustrating the configuration of a semiconductor integrated circuit including a skew correction circuit in a clock distributor. Referring to FIG. 17, clock distributor 604 comprises skew correction circuit 601 in addition to clock distribution circuits 602, 603.

Skew correction circuit 601 receives n-phase clocks generated by multi-phase clock generator circuit 102 through clock distribution circuit 602, corrects skew among the n-phase clocks, and supplies the corrected n-phase clocks to flip-flop 105 of logic circuit 104 through clock distribution circuit 603.

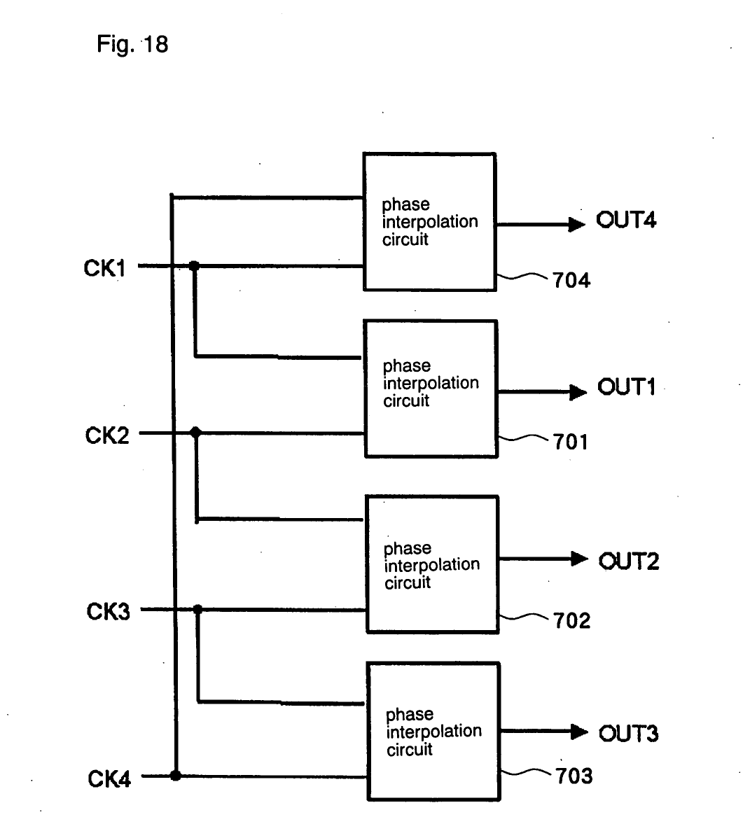

FIG. 18 is a block diagram illustrating an exemplary configuration of the skew correction circuit shown in FIG. 17. Here, lour-phase clocks are illustrated in the skew correction circuit. Referring to FIG. 18, clock skew correction circuit 601 comprises phase interpolation circuits 701-704. Phase interpolation circuits 701-704, which are all identical In configuration, each receive two clocks and deliver a clock at a phase central to the two clocks.

Phase interpolation circuit 701 is applied with clocks CK1, CK2; phase interpolation circuit 702 with clocks CK2, CK3; phase interpolation circuit 703 with clocks CK3, CK4; and phase interpolation circuit 704 with clocks CK4, CK1.

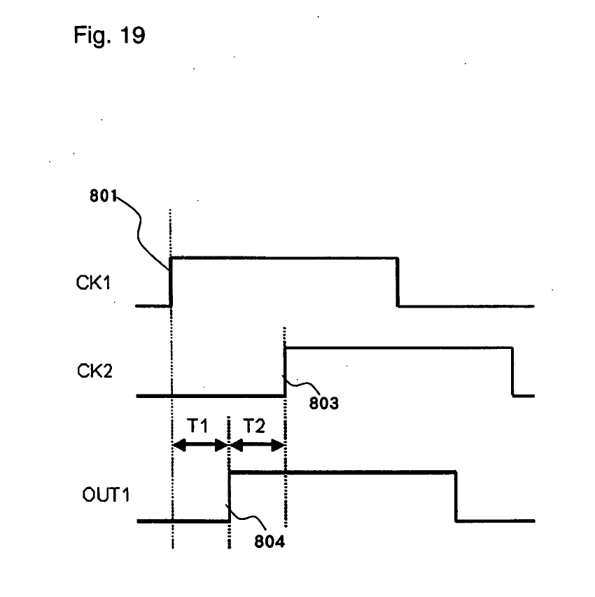

FIG. 19 is a timing diagram representing the operation of the phase interpolation circuits. Giving phase interpolation circuit 701 as an example, phase interpolation circuit 701 is applied with clocks CK1, CK2. Clock CK1 rises at rising timing 801. Clock CK2 rises at rising timing 803. Therefore, phase interpolation circuit 701 delivers output clock OUT1 such that time difference between rising timing 801 of clock CK1 and rising timing 804 of output clock OUT1 is equal to time difference T2 between rising timing 804 of clock CK2 and rising timing 803 of output clock OUT1.

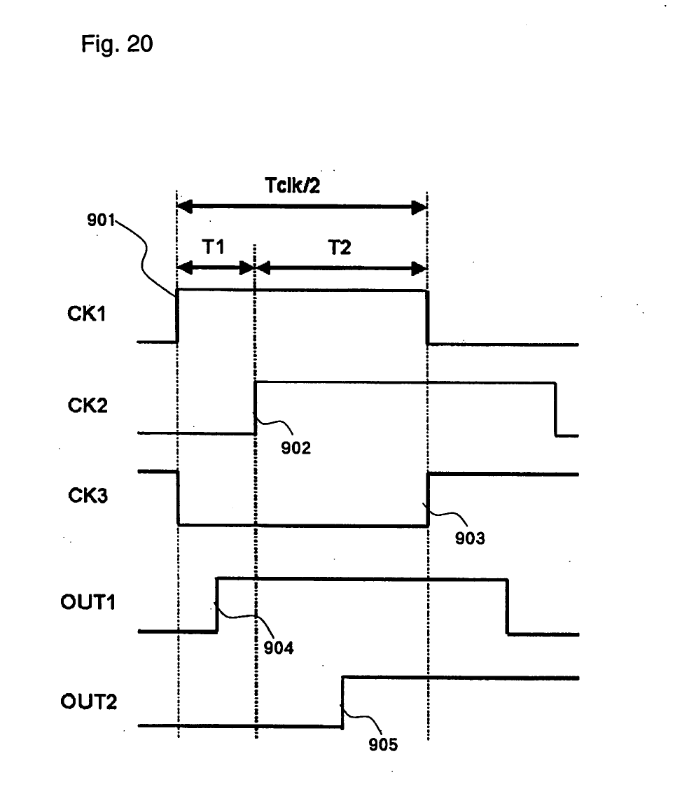

FIG. 20 is a timing diagram representing a clock skew correcting operation performed by the skew correction circuit in FIG. 18. Here, while the time difference between clock CK1 and clock CK3 is ideal in the four-phase clocks (one-half of the clock frequency (=Tclk/2)), clock CK2 rises at a shifted timing.

Output clock OUT1 rises at rising timing 904 which is an intermediate (interpolation) timing between rising timing 901 of clock CK1 and rising timing 903 of clock CK3. In this event, a time difference between rising timing 904 and rising timing 905 is calculated by:
T1/2+T2/2=Tclk/4
where Tclk is the period of the respective clocks.

From the foregoing calculation, it is understood that clock CK2 is corrected to define an ideal clock interval.

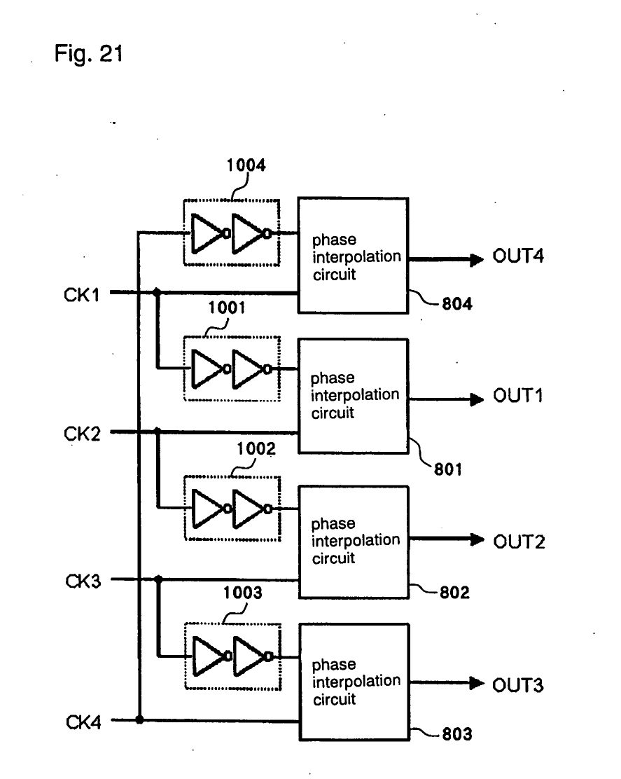

Skew correction circuit may take other configuration than that illustrated in FIG. 18. Referring to FIG. 21, skew correction circuit 601 comprises phase interpolation circuits 801-804, and delay circuits 1001-1004. Phase interpolation circuits 801-804 are identical to those shown in FIG. 18.

The skew correction circuit illustrated in FIG. 21 differs from the counterpart illustrated in FIG. 18 in that clock CK1 applied to phase interpolation circuit 801 is delayed by delay circuit 1001; clock CK2 applied to phase interpolation circuit 802 is delayed by delay circuit 1002; clock CK3 applied to phase interpolation circuit 803 is delayed by delay circuit 1003; and clock CK4 applied to phase interpolation circuit 804 is delayed by delay circuit 1004.

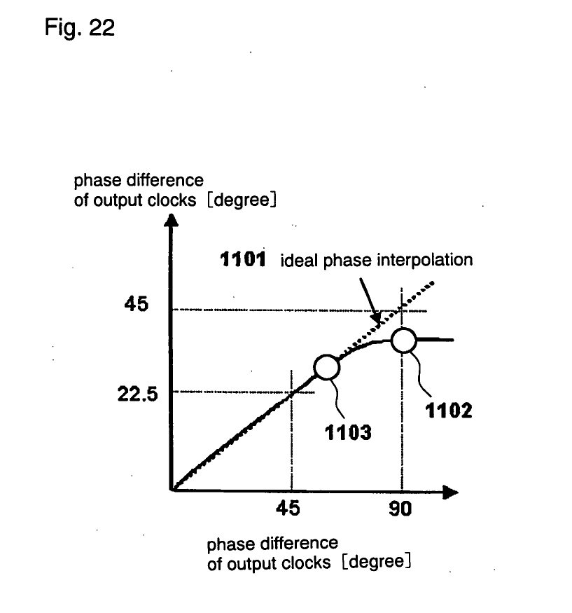

FIG. 22 is a graph showing the phase interpolation characteristics of the phase interpolation circuits shown in FIGS. 18 and 21. Here, the phase interpolation characteristic refers to the characteristic of a phase difference of an output clock with respect to a phase difference of input clocks.

Referring to FIG. 22, it can be seen that there is a certain range of phase difference which can be interpolated by the phase interpolation circuit. For example, the graph of FIG. 22 represents the phase of input clock CK2 on the horizontal axis, and the phase of output clock OUT1 on the vertical axis, with the phase of input clock CK1 being defined at zero. Since the phase interpolation circuit generates an intermediate value of the phase difference between two input clocks, the phase difference of the output clock is one-half of the phase difference between the Input clocks.

Phase interpolation characteristic 1101 is ideal, but in the phase interpolation circuit in FIG. 18, actual phase Interpolation characteristic 1102 deviates from ideal phase interpolation characteristic 1101 when there is a certain phase difference or more, resulting in a degraded skew adjusting function which relies on phase Interpolation.

The skew correction circuit In FIG. 21 additionally comprises delay elements 1001-1004 to reduce a phase difference between two clocks applied to each phase interpolation circuit.

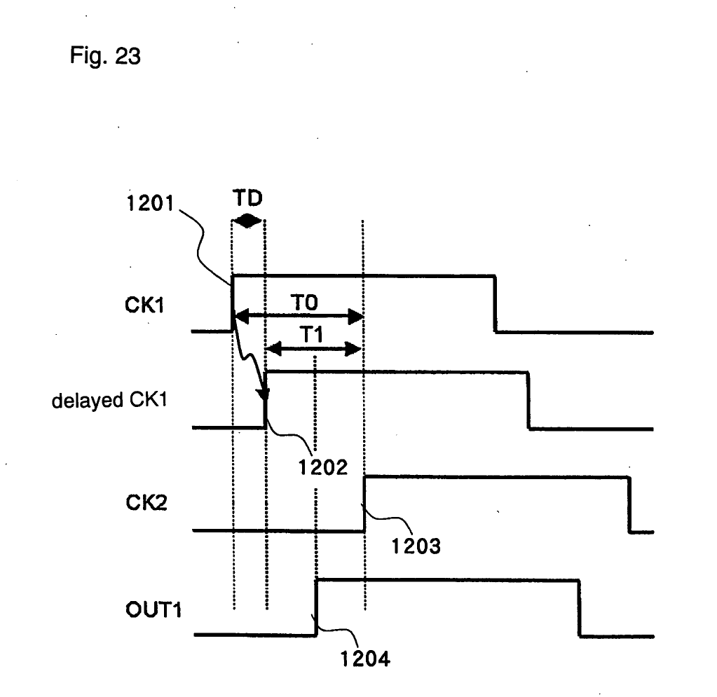

Referring to FIG. 23, input clock CK1 is delayed by delay time TD by delay element 1001 before it is applied to phase interpolation circuit 801.

Input clock CK2 is applied to phase interpolation circuit 801 as it is. By delaying input clock CK1 which advances in phase, the phase difference between clock CK1 and clock CK2 is reduced from phase difference T0 to phase difference T1. Since this means that the relationship between the two input clocks moves from plot 1102 to plot 1103 in FIG. 22, the phase interpolation characteristic becomes closer to the ideal characteristic.

Phase interpolation circuit 801 delivers output clock OUT1 which rises at rising timing 1204 that is at the center between rising timing 1202 of delayed clock CK1 and the rising timing of clock CK2.

By appropriately correcting the skew among n-phase clocks in the manner as described above, a maximum operation margin can be ensured for a logic circuit, thus realizing a semiconductor integrated circuit capable of high-speed operations.

(Third Exemplary Implementation)

In a third exemplary implementation, the clock distributor of this embodiment includes a waveform transform circuit.

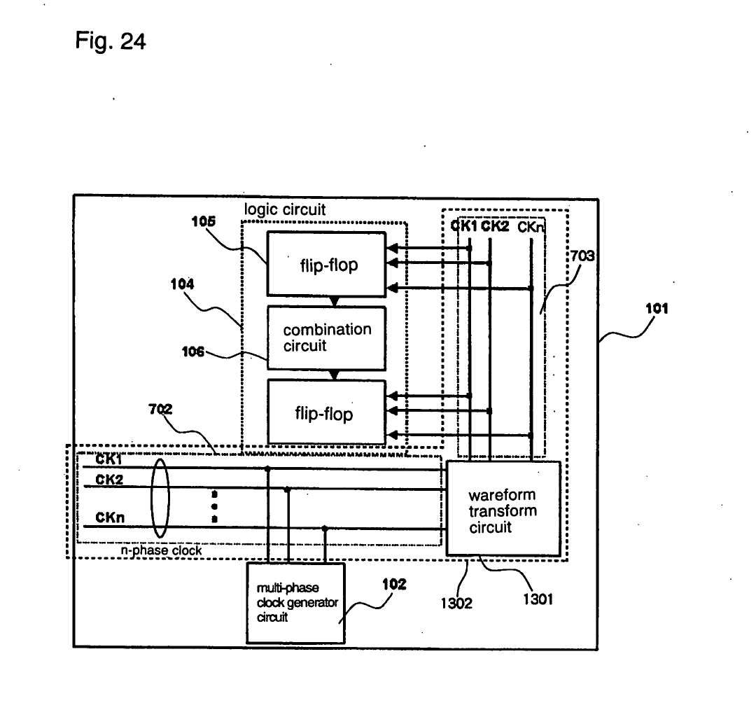

Referring to FIG. 24, clock distributor 1302 differs from that illustrated in FIG. 17 in that waveform transform circuit 1301 is included Instead of skew correction circuit 601.

Waveform transform circuit 1301 is connected to ends of n-phase clocks CK1-CKn generated by multi-phase clock generator circuit 102 and distributed by clock distribution circuit 702. Waveform transform circuit 1301 transforms the waveforms of input clocks applied from clock distribution circuit 702, and applies the resulting input clocks to flip-flop 105 of logic circuit 104 through clock distribution circuit 703.

Waveform transform circuit 1301 transforms each of n-phase clocks CK1-CKn into a waveform which can be correctly recognized by flip-flop 105 of logic circuit 104. The transformation of waveform can be implemented in a variety of configurations depending on the circuit type of flip-flop 105 in logic circuit 104.

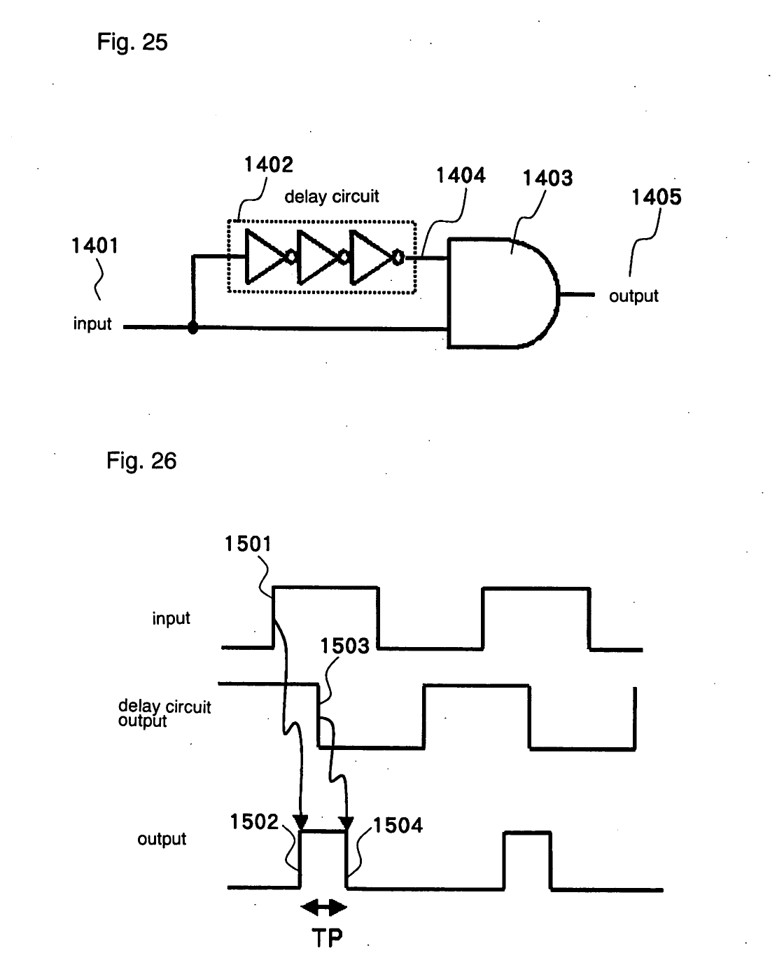

Referring to FIG. 25, waveform transform circuit 1301 comprises delay circuit 1402, and AND circuit 1403. Delay circuit 1402 delays input clock 1401 by a predetermined delay time, and applies inverted signal 1404 to AND circuit 1403. AND circuit 1403 takes logical AND of input clock 1401 and signal 1404 to generate output clock 1405 at a predetermined duty ratio (ratio of a high-level duration to a low-level duration).

As illustrated in FIG. 26, rising timing 1502 of output clock 1405 depends on rising timing 1501 of input clock 1401, and falling timing 1504 of output clock 1405 depends on falling timing 1503 of signal 1404. Therefore, a desired duty ratio can be provided by adjusting a delay time of delay circuit 1402.

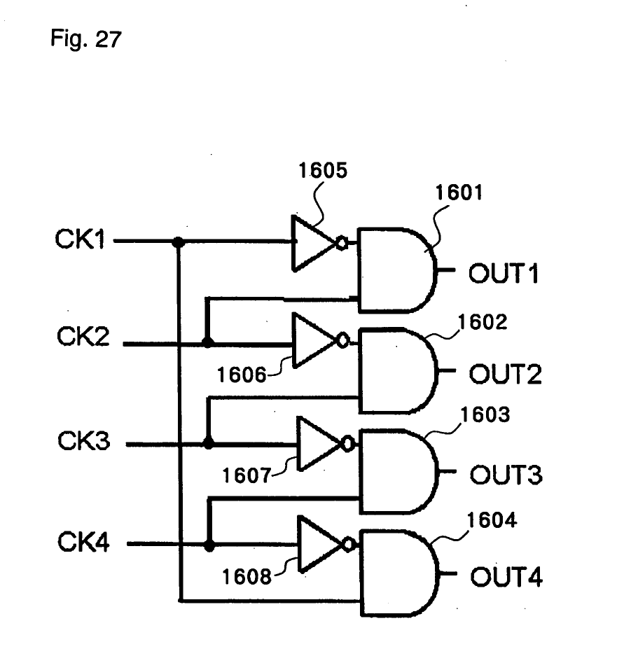

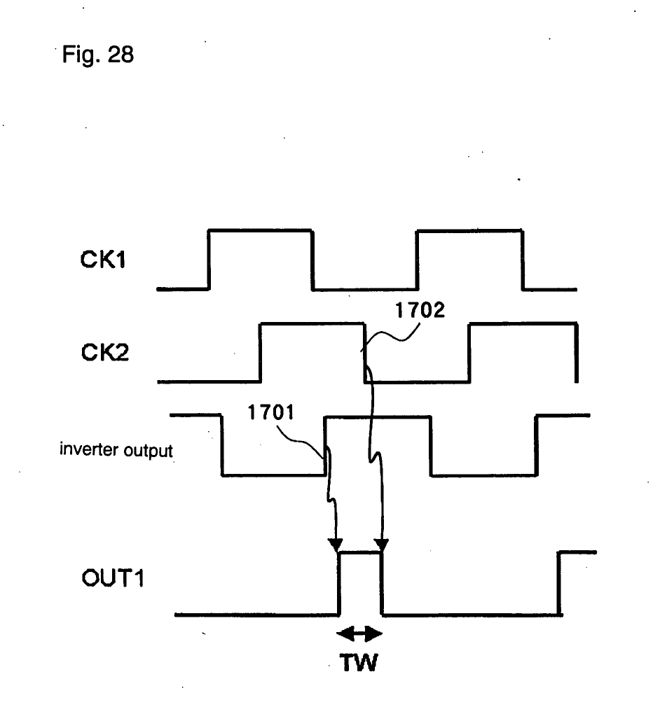

FIG. 27 is a schematic circuit diagram illustrating another exemplary configuration of the waveform transform circuit illustrated in FIG. 24. FIG. 28 is a timing diagram representing the operation of the waveform transform circuit illustrated in FIG. 27.

Referring to FIG. 27, waveform transform circuit 1301 comprises AND circuits 1601-1604 and inverters 1605-1608. Inverter 1605 inverts input clock CK1, and applies inverted clock CK1 to AND circuit 1601; inverter 1606 inverts input clock CK2, and applies inverted clock CK2 to AND circuit 1602; inverter 1607 inverts input clock CK3, and applies inverted clock CK3 to AND circuit 1603; and inverter 1608 inverts input clock CK4, and applies inverted clock CK4 to AND circuit 1604.

AND circuit 1601 takes logical AND of the output of inverter 1605 and clock CK2 to generate output clock OUT1. AND circuit 1602 takes logical AND of the output of inverter 1606 and clock CK3 to generate output clock OUT2. AND circuit 1603 takes logical AND of the output of inverter 1607 and clock CK3 to generate output clock OUT3. AND circuit 1604 takes logical AND of the output of inverter 1608 and clock CK4 to generate output clock OUT4.

As illustrated in FIG. 28, for example, output clock OUT1 rises at a timing which is determined by rising timing 1701 of the output of inverter 1605, and falls at a timing which is determined by falling timing 1702 of input clock CK2. From the foregoing, high-level duration TW of output clock OUT1 is calculated by:
TW=Tclk/4−Td

Clocks OUT1-OUT4 have such waveforms that their high-level durations do not overlap with one another. The use of these clocks OUT1-OUT4 can simplify the circuit of the flip-flop illustrated in FIG. 10.

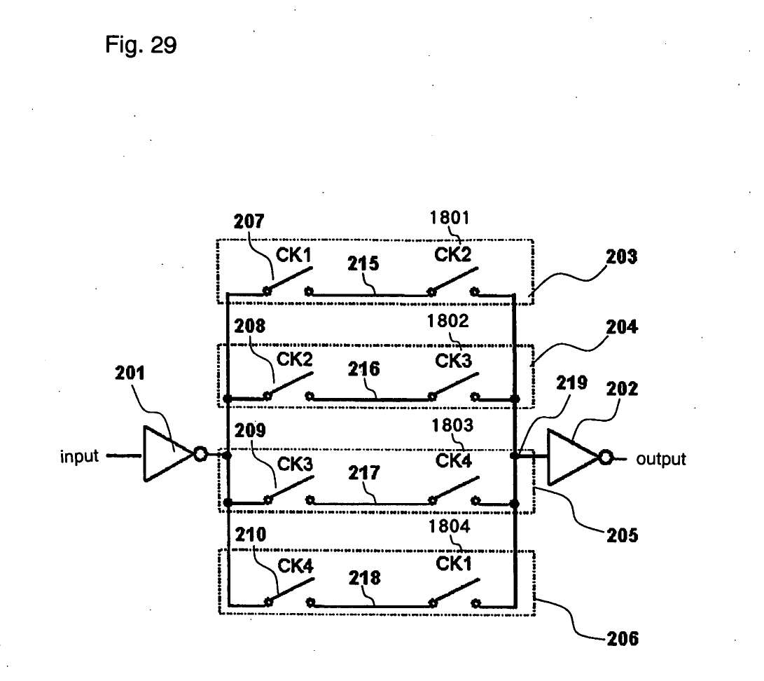

FIG. 29 illustrates the configuration of a flip-flop which is substituted for that illustrated in FIG. 10. The flip-flop of FIG. 29 differs from that of FIG. 10 in that switch circuits 211-214 on the slave side are replaced with switch circuits 1801-1804. Switch circuit 1801 on the slave side is conductive when clock CK2 is at high level. Switch circuit 1802 on the slave side Is conductive when clock CK3 is at high level. Switch circuit 1803 on the slave side is conductive when clock CK4 is at high level. Switch circuit 1804 on the slave side is conductive when clock CK1 is at high level.

While the circuit of FIG. 10 needs to take a logical AND of two clocks or establishing the condition for making the switch circuit on the slave side conductive, the circuit of FIG. 29 eliminates this requirement and is therefore simple in circuit configuration. By thus transforming clock waveforms appropriately for a particular circuit type of a flip-flop in a logic circuit, the logic circuit can be simplified in configuration and can operate at high speeds.

(Fourth Exemplary Implementation)

In the semiconductor integrated circuit of this embodiment illustrated above, multi-phase clock generator circuit 102 generates n-phase clocks, and clock distribution circuit 103 supplies the n-phase clocks to logic circuit 104. However, the semiconductor integrated circuit is not limited to the foregoing configuration. For example, as a fourth exemplary implementation, after distributing a single-phase clock generated by a single-phase clock generator circuit, the single-phase clock may be transformed into n-phase clocks at the end of a clock distribution circuit, such that the n-phase clocks are supplied to logic circuit 104.

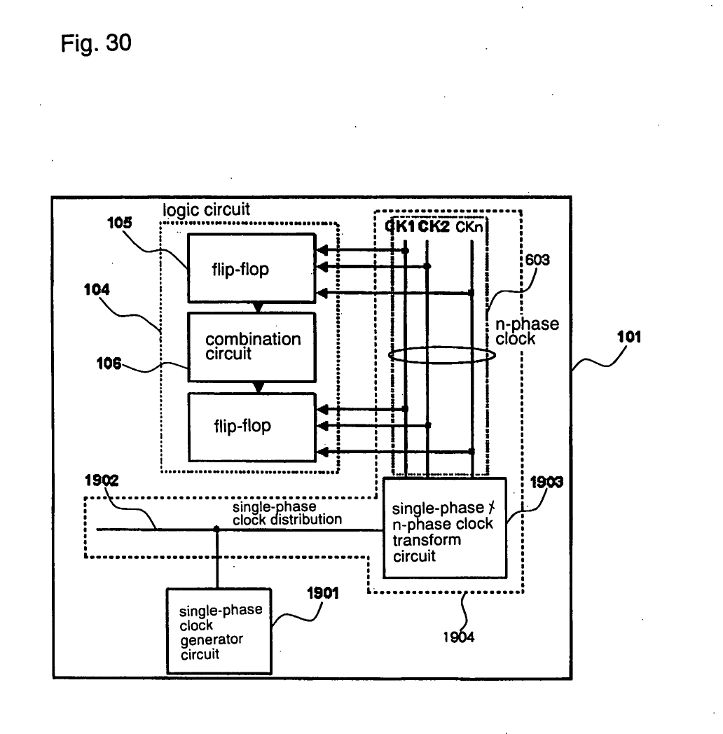

Referring to FIG. 30, the semiconductor integrated circuit of the fourth exemplary implementation differs from that illustrated in FIG. 9 in that multi-phase clock generator circuit 102 is replaced with single-phase clock generator circuit 1901, and clock distributor 103 is replaced with clock distributor 1904.

Single-phase clock generator circuit 1901 generates a single-phase clock which is sent to single-phase/n-phase clock transform circuit 1903 through clock distribution circuit 1902 of clock distributor 1904. The clock generated by single-phase clock generator circuit 1901 is at frequency f. Single-phase/n-phase clock transform circuit 1903, which Is located at one end of a clock wire, generates n-phase clocks from the single-phase clock which is a reference signal, and applies the generated n-phase clocks to flip-flop 105 of logic circuit 104 through clock distribution circuit 603. N-phase clocks CK1-CKn applied from single-phase/n-phase clock transform circuit 1903 to flip-flop 105 are the same in frequency at f but different in phase from one another.

Likewise, in the foregoing configuration, when the clocks of clock distribution circuit 1902 and clock distribution circuit 603 are at frequency f, the operating frequency of logic circuIt 104 can be increased n times as high as frequency f (fxn). In the fourth exemplary implementation, logic circuit 104 employed herein can be similar to the aforementioned one.

While the example shown herein generates a single-phase clock and transforms the single-phase clock, used as a reference signal, into n-phase clocks, the present invention is not limited to this example. Another example may generate two-phase clocks which can be transformed into n-phase clocks.

(Fifth Exemplary Implementation)

In a fifth exemplary implementation, the semiconductor integrated circuit of this embodiment may be configured such that after n-phase clocks generated by multi-phase clock generator circuit 102 are distributed, the n-phase clocks are transformed into a single-phase clock which is supplied to logic circuit 104.

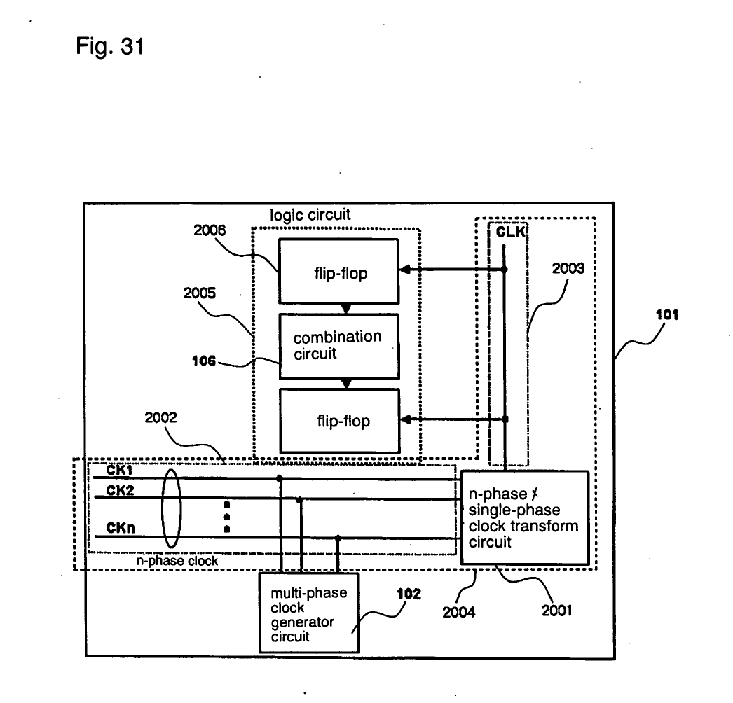

A semiconductor integrated circuit illustrated in FIG. 31 differs from that illustrated in FIG. 9 in that clock distribution unit 103 is replaced with clock distribution unit 2004, and logic circuit 104 is replaced with logic circuit 2005.

N-phase clocks CK1-CKn generated by multi-phase clock generator circuit 102 are distributed by clock distribution circuit 2002 as they are in a region in which wires have a long length and strict bandwidth conditions are imposed. Assume that n-phase clocks CK1-CKn are at frequency f. Then, n-phase clocks CK1-CKn are transformed into a single-phase clock CLK at frequency (fxn) by n-phase/single-phase clock transform circuit 2001 at the end of clock distribution circuit 2002. N-phase/single-phase clock transform circuit 2001 is disposed near logic circuit 2005. The single-phase clock CLK is distributed by clock distribution circuit 2003 through a relatively short length of a wire between n-phase/single-phase clock transform circuit 2001 and logic circuit 2005. Logic circuit 2005 comprises flip-flop 2006 which is a general one, and fetches data In synchronization with clock CLK.

With the foregoing configuration, in a region which entails a long wire length and therefore imposes strict bandwidth conditions, n-phase clocks at a lower frequency are distributed, and applied to logical circuit 2005 through N-phase/single-phase clock transform circuit 2001 immediately before logic circuit 2005. Therefore, the operating frequency (f×n) of logic circuit 2005 can be increased n times as high as clock frequency f of the n-phase clocks. Also, since logic circuit 2005 can be created using a conventional circuit for single-phase clock, logic circuit 2005 is simple in designing.

(First Exemplary Circuit)

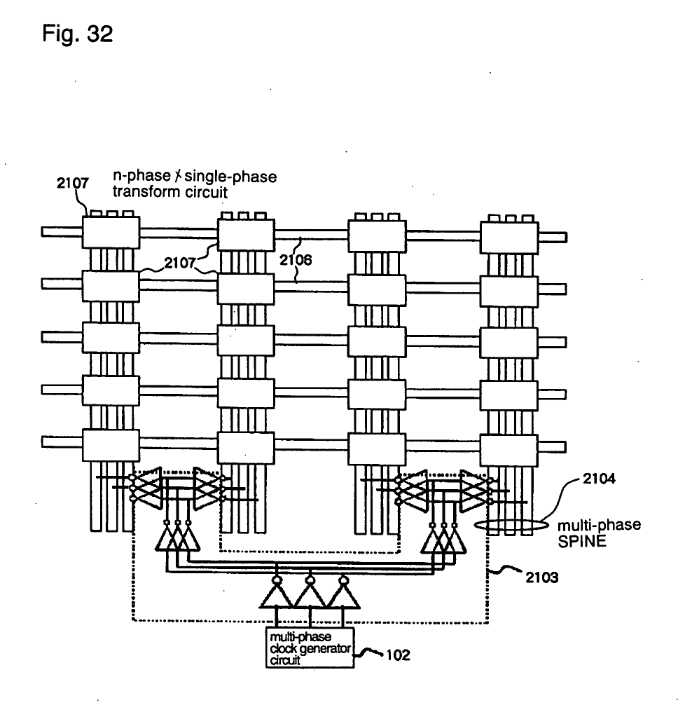

FIG. 31 illustrates a semiconductor integrated circuit which is a first exemplary circuit of the fifth exemplary implementation, wherein the SPINE scheme may be employed for clock distributor 2004. Referring to FIG. 32, corresponding to clock distributor 2004 in FIG. 31, a clock distributor comprises clock branch circuit 2103, multi-phase SPINE 2104, n-phase/single-phase transform circuits 2107, and clock wires 2106.

Clock branch circuit 2103, which comprises a plurality of buffers, branches each of n-phase clocks CK1-CKn generated by multi-phase clock generator circuit 102 to each SPINE of basic multi-phase SPINE 2104. A plurality of n-phase/single-phase clock transform circuits 2107 are connected to multi-phase SPINE 2104. The N-phase clocks are distributed as they are from multi-phase clock generator circuit 102 to multi-phase SPINE 2104, where there is a long wire length and strict limitations are imposed to the clock frequency bandwidth.

Each n-phase/single-phase clock transform circuit 2107, which corresponds to n-phase/single-phase clock transform circuit 2001 in FIG. 31, transforms n-phase clocks into a single-phase clock. The single-phase clock is distributed after clock wire 2106 which is in a grid shape and is relatively loosely limited in the frequency bandwidth.

According to the foregoing configuration, n-phase clocks at a lower frequency are distributed in a region which is strictly limited in the frequency bandwidth, while a single-phase clock at a higher frequency is distributed in a region which is loosely limited in the frequency bandwidth, thereby solving the problem implied in the distribution of a fast clock, enabling a logic circuit to be build using a conventional ordinary flip-lop, and facilitating the designing of a semiconductor integrated circuit capable of high-speed operations.

(Second Exemplary Circuit)

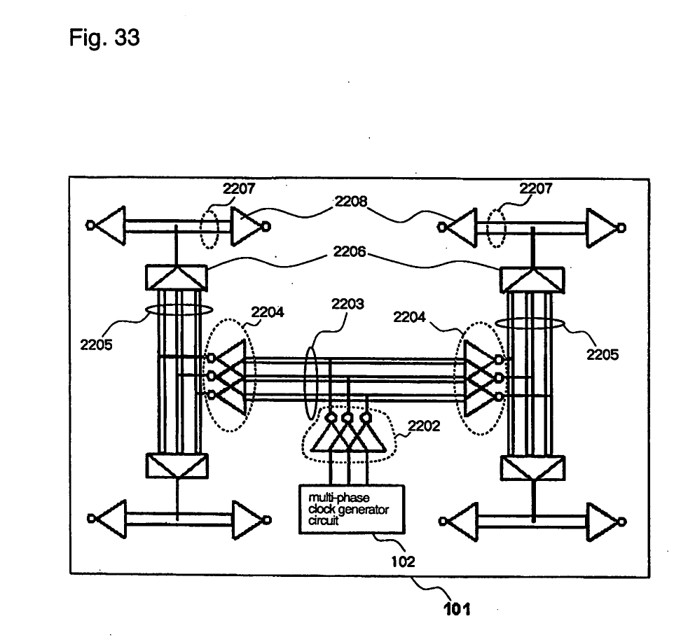

As a second exemplary circuit of the fifth exemplary implementation, the semiconductor integrated circuit illustrated in FIG. 31 may employ the H-tree scheme for clock distributor 2004. Referring to FIG. 33, corresponding to clock distributor 2004 in FIG. 31, a clock distributor comprises buffer groups 2202, 2204, clock wire groups 2203, 2205, n-phase/single-phase clock transform circuits 2206, clock wires 2207; and buffers 2208.

First-stage buffer group 2202 branches n-phase clocks generated by multi-phase clock generator circuit 102 into two from the center of each clock wire in clock wire group 2203 toward both ends of the same. Buffers belonging to second-stage buffer group 2204 are connected at both ends of each of clock wires belonging to clock wire group 2203 for further branching an associated clock into two toward both ends of each clock wire in clock wire groups 2205.

N-phase/single-phase clock transfer circuits 2006 are connected to both ends of respective clock wire groups 2205. Each n-phase/single-phase clock transform circuit 2006 transforms n-phase clocks into a single-phase clock, and branches the single-phase clock into two from the center of clock wire 2207 toward both ends of the same. Buffers 2008 are connected to both ends of each clock wire 2207 for distributing the single-phase clock to a logic circuit.

According to the foregoing configuration, as is the case with the configuration of FIG. 32, n-phase clocks at a lower frequency are distributed in a region which is strictly limited in the frequency bandwidth, while a single-phase clock at a higher frequency is distributed in a region which is loosely limited in the frequency bandwidth, thereby solving the problem implied in the distribution of a fast clock, enabling a logic circuit to be build using a conventional ordinary flip-flop, and facilitating the designing of a semiconductor integrated circuit capable of high-speed operations.

While the foregoing example distributes the single-phase clock from the third stage onward by n-phase/single-phase clock transform circuit, the present invention is not limited to this particular way of distributing the single-phase clock. A determination as to from which stage the single-phase clock should be distributed may be made in accordance with the frequency of the clock and the wire length.

(Second Embodiment)

Now, description will be made on a second embodiment of the present invention. A semiconductor integrated circuit of the second embodiment is similar in configuration to that of FIG. 9, but differs in that a dynamic logic circuit is included instead of logic circuit 104.

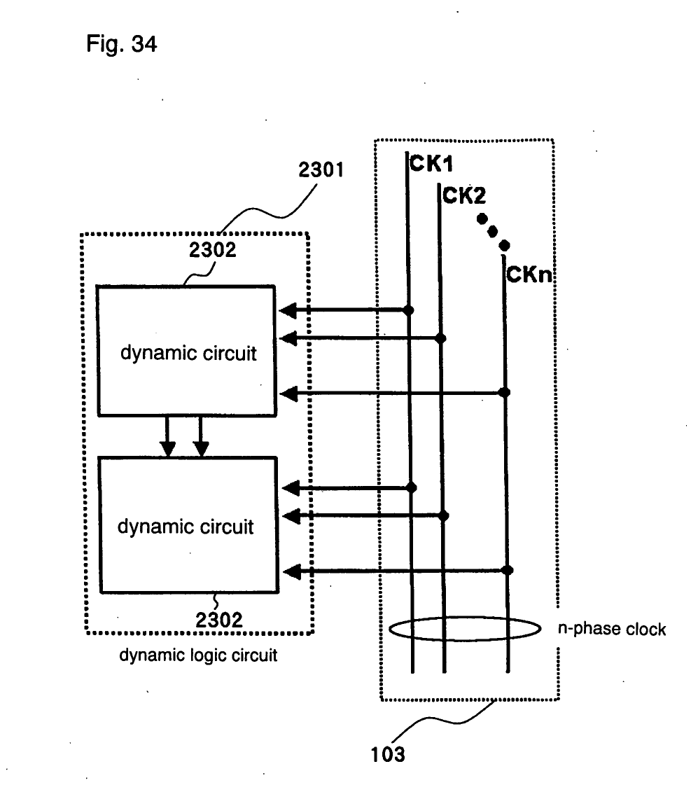

Referring to FIG. 34, dynamic logic circuit 2301 comprises a plurality of dynamic circuits 2302. N-phase clocks CK1-CKn from clock distributor 103 are applied to dynamic circuits 2302 of dynamic logic circuit 2301.

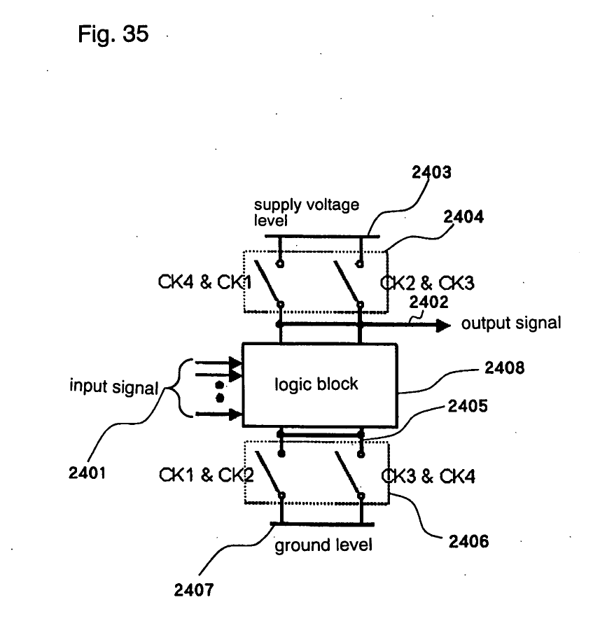

FIG. 35 is a block diagram illustrating the configuration of the dynamic circuit shown in FIG. 34. The example illustrated herein employs four-phase clocks CK1-Ck4. Dynamic circuit 2302, which alternately repeats a preparatory charging stage and an evaluation stage in synchronization with n-phase clocks, comprises preparatory charging switch 2404, evaluation stage switch 2406, and logic block 2408. The preparatory charging stage involves preparatory charging of logic block 2408 and resetting of logic. The evaluation stage involves a logical operation performed in accordance with an input signal. Logic block 2408 comprises output terminal 2402 and intermediate terminal 2405.

Preparatory charging switch 2404 brings output terminal 2402 of logic block 2408 to supply voltage level 2403 when clocks CK1, CK4 are both at high level, or when clocks CK2, CK3 are both at high level. This is the preparatory charging stage.

Evaluation stage switch 2405 brings intermediate terminal 2405 to a ground level when clocks CK1, CK2 are both at high level, or when clocks CK3, CK4 are both at high level. This is the evaluation stage.

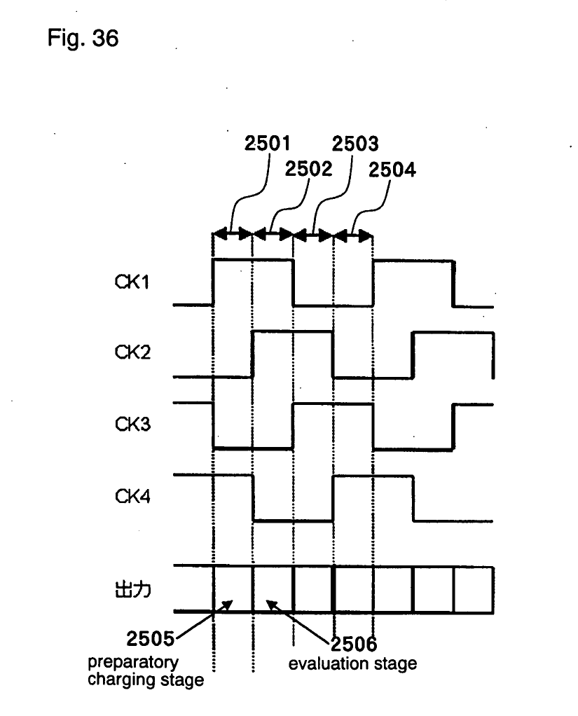

Referring to FIG. 36, in section 2501, preparatory charging switch 2404 is conductive because both clocks CK1, CK2 are at high level, causing evaluation stage switch 2406 to be nonconductive. Consequently, output terminal 2402 is clamped to high level irrespective of an input signal, bringing dynamic circuit 2302 into preparatory charging stage 2505.

Next, with a transition to section 2502, clock CK4 changes to low level, and clock CK2 changes to high level, causing preparatory charging switch 2404 to be nonconductive and evaluation stage switch 2406 to be conductive. In this event, dynamic circuit 2302 is brought into evaluation stage 2506 in which the level of output terminal 2402 depends on whether logic block 2408 is conductive or nonconductive.

Likewise, dynamic circuit 2302 is brought into the preparatory charging stage in section 2503, and into the evaluation stage in section 2504. In this way, dynamic circuit 2302 alternately repeats the preparatory charging stage and evaluation stage each time any single-phase clock of the n-phase clocks rises. Therefore, assuming that each of n-phase clocks is at frequency f, the operating frequency of dynamic circuit 2302 is calculated by (n×f/2). For example, when dynamic circuit 2304 is used with four-phase clocks, the operating frequency of dynamic circuit 2304 is calculated by 2×f, i.e., the operating frequency is twice as high as the frequency of each of the four-phase clocks.

According to the foregoing configuration, the dynamic circuit alternately repeats the preparatory charging stage and evaluation stage each time any of the n-phase clocks rises, thereby enabling the logic circuit to operate at a frequency higher than that of the n-phase clocks used therewith.

(Third Embodiment)

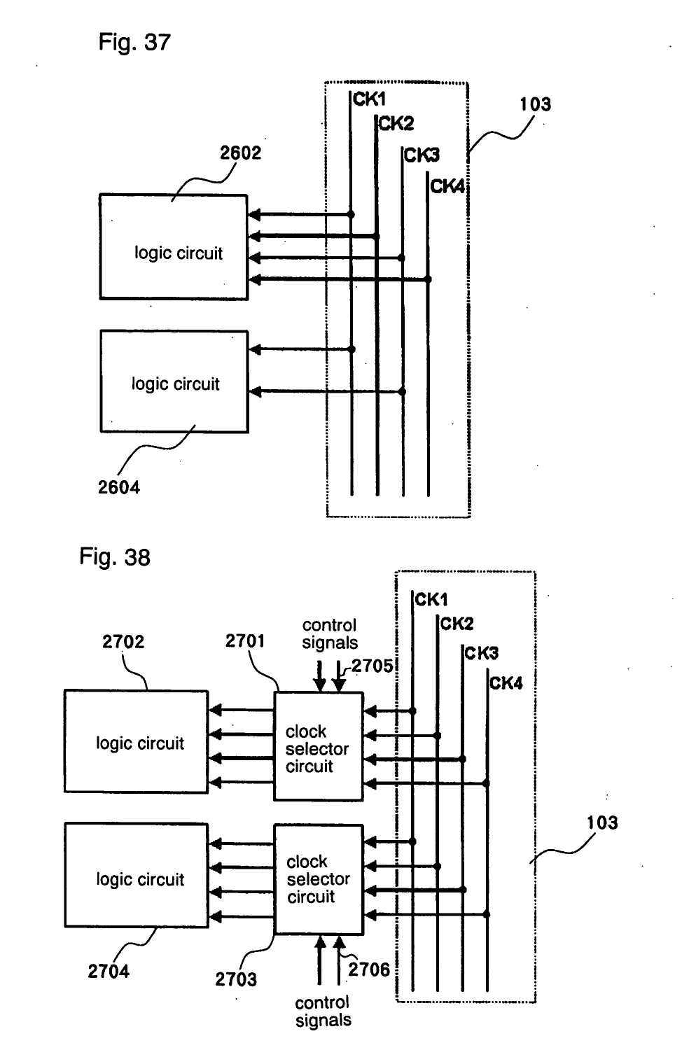

Next, description will be made on a third embodiment of the present invention. A semiconductor integrated circuit according to the third embodiment is similar in configuration to that illustrated in FIG. 9, but differs in that it includes a mixture of logic circuits which operate at different frequencies from one another. FIG. 37 illustrates a semiconductor integrated circuit using four-phase clocks CK1-CK4. Assume that each of clocks CK1-CK4 is at frequency.

While each logic circuit 2602, 2604 can be synchronized to an arbitrary number of clocks from one to n, logic circuit 2602 is applied with all four-phase clocks CK1-CK4, and logic circuit 2604 is applied with two-phase clocks CK1, CK3.

Although semiconductor integrated circuits are required to operate at higher speeds, high-speed operations are not always required in all parts. According to this embodiment, since an arbitrary number can be selected for the phases of clocks used in each logic circuit, a higher operating frequency is provided in a logic circuit which requires high-speed operations, and design conditions such as a wire length are alleviated for a logic circuit which does not require high-speed operations, whereby the resulting semiconductor integrated circuit can operate at desired speeds.

(Fourth Embodiment)

Next, description will be made on a fourth embodiment of the present invention. A semiconductor integrated circuit according to the fourth embodiment comprises a clock selector circuit between a clock distributor and each logic circuit, and can switch the operating frequency of the logic circuit by the clock selector circuit.

Referring to FIG. 38, n-phase (here, four-phase) clocks are applied from clock distributor 103 to clock selector circuits 2701, 2703.

Clock selector circuit 2701 selects an arbitrary one from the n-phase clocks in accordance with an instruction carried on control signal 2705, and applies the selected clock to logic circuit 2702. Likewise, clock selector circuit 2703 selects an arbitrary one from the n-phase clocks in accordance with an instruction carried on control signal 2706, and applies the selected clock to logic circuit 2704. Each of clock selector circuits 2701, 2703 can switch the clock not only while logic circuits 2702, 2704 are waiting but also while they are operating. Thus, the operating frequency can be arbitrarily changed for each logic circuit 2702, 2704.

According to the configuration in the fourth embodiment, since there is no need for changing the frequency of clocks generated by multi-phase clock generator circuit, the operating frequencies of logic circuits 2702, 2704 can be switched without stopping the operation thereof, thereby avoiding a useless time.

(Fifth Embodiment)

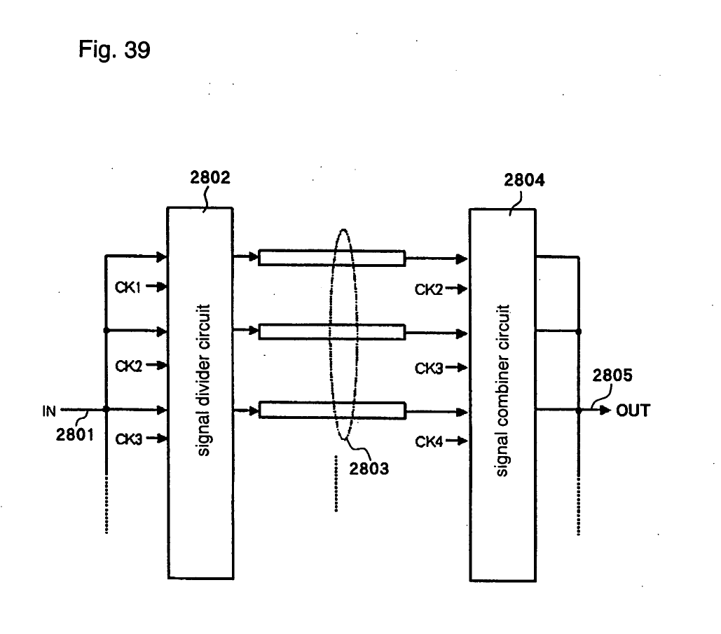

Next, description will be made on a fifth embodiment of the present invention. A semiconductor integrated circuit according to the fifth embodiment enables high-speed signals other than clocks to propagate on wires over a long distance. FIG. 39 is a block diagram illustrating the configuration around high-speed signal wires in the semiconductor integrated circuit according to the fifth embodiment. The semiconductor integrated circuit of the fifth embodiment comprises signal divider circuit 2802, signal wires 2803, and signal combiner circuit 2804 between logic circuits.

Signal divider circuit 2802 divides input signal 2801 from a previous logic circuit (not shown) into a plurality of signals (here n) which are sent to signal combiner circuit 2804 through a plurality of signal wires 2803. Signal wires 2803 extends over a long distance, such as a bus wire which imposes strict limitations on frequency. Signal combiner circuit 2804 combines a plurality of signals received from signal wires 2803 to generate output signal 2805 which is sent to a subsequent logic circuit (not shown).

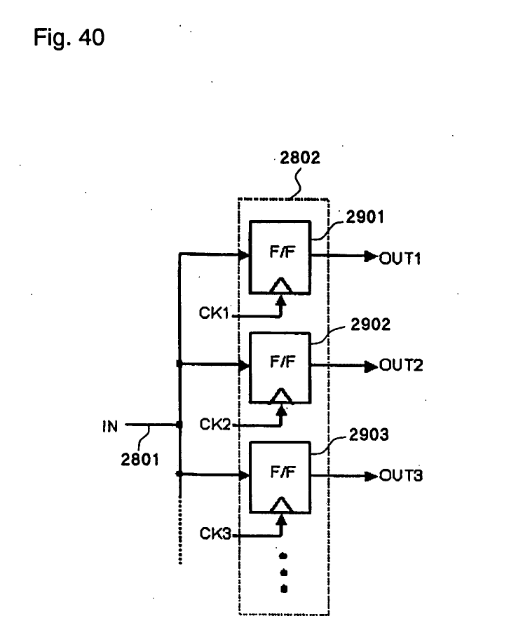

Signal divider circuit 2802 receives input signal 2801 at frequency f from a previous logic circuit which operates at operating frequency f, and divides input signal 2801 into n to reduce the frequency of each signal to f/n. Referring to FIG. 40, signal divider circuit 2802 comprises a plurality (n, but only three of them are shown in FIG. 40) flip-flops 2901-2903.

Each of flip-flops 2901-2903 . . . is applied with input signal 2801. Each of flip-flops 2901-2903 . . . fetches data with corresponding clock CK1-CK3 . . . to deliver signals OUT1-OUT3 . . . , respectively.

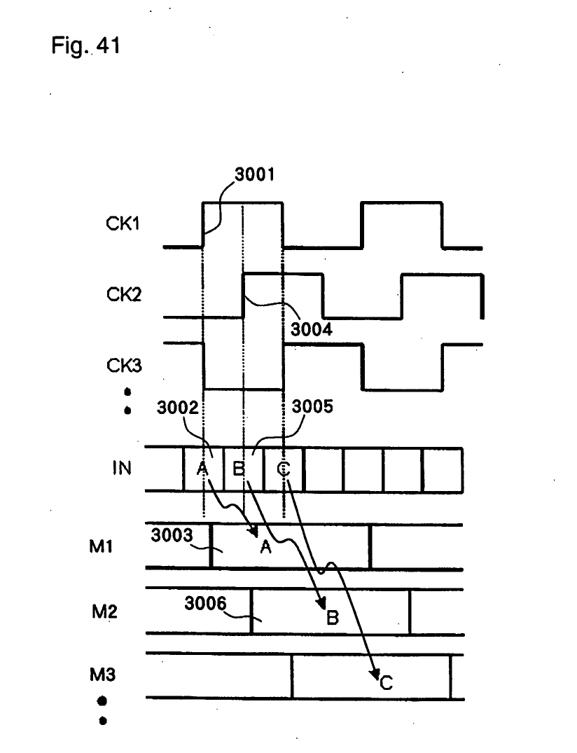

Referring to FIG. 41, flip-flop 2901 fetches data A of input signal 2801 at rising timing 3001 of clock CK1. Next, flip-flop 2902 fetches data B of input signal 2801 at rising timing 3004 of clock CK2. As the respective flip-flops repeat this operation, the input signal is divided into n signals M1-Mn delivered from the respective flip-flops. Also, the operating frequency of each signal M1-Mn is 1/n as high as the operating frequency of input signal IN.

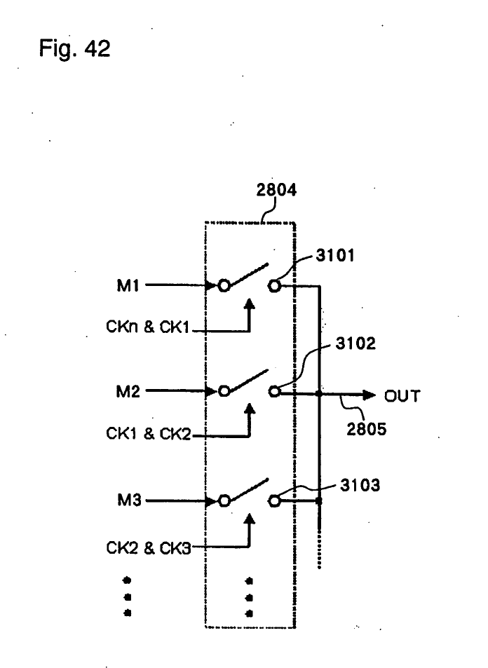

Referring to FIG. 42, signal combiner circuit 2804 comprises a plurality (n, but only three of them are shown in FIG. 42) of switches 3101-3103 . . . .

For combining n signals M1-Mn into one, one of switches 3101-3103 . . . conducts in order. Switch 3103 is conductive when clocks CKn, CK1 are both at high level. Switch 3102 is conductive when clocks CK1, CK2 are both at high level. Switch 3103 is conductive when clocks CK2, CK3 are both at high level.

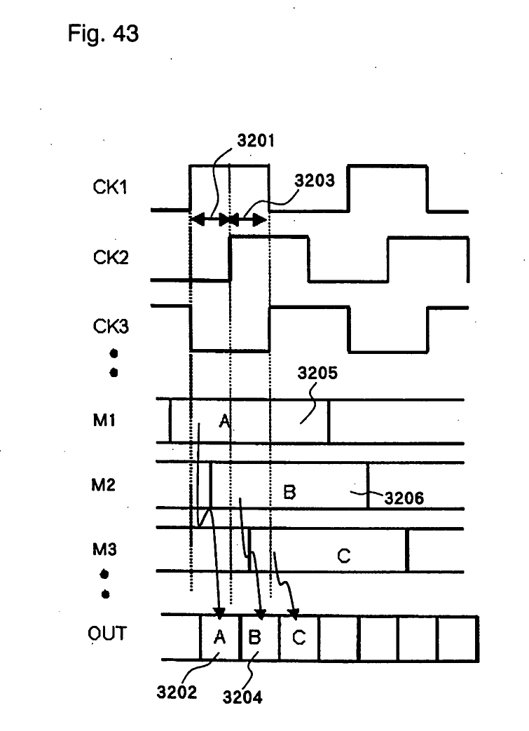

Referring to FIG. 43, in section 3201, switch 3101 is conductive because clocks CKn, CK1 are both at high level, causing data A existing in section 3205 of signal M1 to appear in section 3202 of an output signal. In section 3203, switch 3102 is conductive because clocks CK1, CK2 are both at high level, causing data B existing in section 3206 of signal M2 to appear in section 3204 of the output signal. In this way, n signals M1-Mn are combined into single signal OUT.

According to this embodiment, a high-speed signal is divided into a plurality of low-speed signals by signal divider circuit 2802, and the divided signals are transmitted through long-distance signal wires 2803 and combined into a single high-speed signal by signal combiner circuit 2804, so that the high speed signal can be transmitted on the wires over a long distance.

While the present invention has been described in connection with the first to fifth embodiments, it should be understood that the present invention is not limited to these embodiments or to the examples described above, but the foregoing embodiments or examples can be modified as appropriate within the technical idea of the present invention.

While preferred embodiments of the present invention have been described using specific terms, such description is for illustrative purposes only, and it is to be understood that changes and variations may be made without departing from the spirit or scope of the following claims.

1. An integrated circuit configured to operate using multi-phase clocks, comprising:
a clock supply unit for generating multi-phase clocks comprised of plural-phase clocks which are the same in clock frequency but different in phase from one another; and
at least one logic circuit capable of operating at an operating frequency higher than the clock frequency in synchronization with the multi-phase clocks supplied thereto by said clock supply unit.

2. The integrated circuit according to claim 1, wherein said clock supply unit includes:
a clock generator circuit for generating the multi-phase clocks; and
a clock distributor for distributing the multi-phase clocks generated by said clock generator circuit within said integrated circuit.

3. The integrated circuit according to claim 1, wherein said clock supply unit includes:
a clock generator circuit for generating a single-phase or two-phase clocks at the clock frequency for use as a reference signal;
a clock distributor for distributing the reference signal generated by said clock generator circuit within said integrated circuit, and for transforming the distributed reference signal into said multi-phase clocks and applying the multi-phase clocks to said logic circuit.

4. The integrated circuit according to claim 3, wherein said clock distributor includes:
a first clock distribution circuit for distributing the reference signal generated by said clock generator circuit within said integrated circuit;
a clock transform circuit for transforming the reference signal distributed by said first clock distribution circuit Into the multi-phase clocks; and
a second clock distribution circuit for applying said logic circuit with the multi-phase clocks generated by said clock transform circuit.

5. The integrated circuit according to claim 1, wherein said logic circuit includes a data holder circuit which is synchronized with two or more clocks included in said multi-phase clocks at an operating frequency twice or more as high as the clock frequency.

6. The integrated circuit according to claim 5, wherein said data holder circuit includes a plurality of data holder elements arranged in parallel for holding data in synchronization with each of the two or more clocks.

7. The integrated circuit according to claim 5, wherein said data holder circuit includes:
at least one latch circuit for delivering a value determined by data for a predetermined time period in synchronization with at least two of the clocks; and
a combiner circuit for sequentially delivering the value delivered from each said latch for the predetermined time period.

8. The integrated circuit according to claim 1, wherein said logic circuit includes a least one dynamic circuit, said dynamic circuit alternately repeating a reset and a logical operation using two or more clocks included in the multi-phase clocks.

9. The integrated circuit according to claim 1, wherein each of said logic circuits operates at an independent operating frequency in synchronization with a predetermined number of clocks selected from the multi-phase clocks for each of said logic circuits.

10. The integrated circuit according to claim 1, wherein said clock supply unit includes:
a clock generator circuit for generating the multi-phase clocks; and
a clock distributor for distributing the multi-phase clocks generated by said clock generator circuit within said integrated circuit, and for transforming the distributed multi-phase clocks into a single-phase clock at a frequency higher than the clock frequency and applying the single-phase clock to said logic circuit.

11. The integrated circuit according to claim 10, wherein said clock distributor includes:
a first clock distribution circuit for distributing the multi-phase clocks generated by said clock generator circuit within said integrated circuit;
a clock transform circuit for transforming the multi-phase clocks distributed by said first clock distribution circuit into the single-phase clock; and
a second clock distribution circuit for applying said logic circuit with the single-phase clock generated by said clock transform circuit.

12. The integrated circuit according to claim 1, wherein said clock supply unit includes an adjuster circuit for adjusting the multi-phase clocks.

13. The integrated circuit according to claim 12, wherein said adjuster circuit corrects the multi-phase clocks for skew among the clocks included in the multi-phase clocks.

14. The integrated circuit according to claim 12, wherein said adjuster circuit transforms the waveforms of the clocks included in the multi-phase clocks.

15. The integrated circuit according to claim 14, wherein said adjuster circuit transforms the waveforms of said clocks into pulsed waveforms.

16. The integrated circuit according to claim 1, wherein said clock supply unit includes:
a clock selector circuit for selecting different clocks with which said logic circuit is synchronized from the multi-phase clocks when said logic circuit is operating and waiting, respectively.

17. The integrated circuit according to claim 1, wherein said logic circuit includes a signal divider circuit for temporally dividing data transmitted on a signal into two or more signals to send the data at a lower frequency.

18. The integrated circuit according to claim 17, wherein said logic circuit includes a signal combiner circuit to combine the two or more signals divided by said divider circuit into one to restore the data.
